(19) United States
(12) Patent Application Publication
(10) Pub. No.: US 2014/0355978 A1
(43) Pub. Date: Dec. 4, 2014

(54) OPTICAL TRANSMISSION SYSTEM, OPTICAL TRANSMISSION APPARATUS, AND OPTICAL TRANSMISSION METHOD

(71) Applicants: FUJITSU LIMITED, Kawasaki-shi (JP); FUJITSU TELECOM NETWORKS LIMITED, Kawasaki-shi (JP)

(72) Inventors: TOMOYUKI SAKATA, Fukuoka (JP); Koji BATO, Fukuoka (JP); Tatsuro Kishida, Fukuoka (JP); Wataru Kawasaki, Kawasaki (JP); Tatsuhiko Saito, Kawasaki (JP)

(73) Assignees: FUJITSU LIMITED, Kawasaki-shi (JP); FUJITSU TELECOM NETWORKS LIMITED, Kawasaki-shi (JP)

(21) Appl. No.: 14/287,770

(22) Filed: May 27, 2014

(30) Foreign Application Priority Data
Jun. 4, 2013 (JP) 2013-118338

(51) Int. Cl. H04B 10/25; H04B 10/079; H04J 14/02

(52) U.S. Cl. CPC H04B 10/25; H04J 14/02; H04B 10/0795
USPC 398/25

(57) ABSTRACT

An optical transmission system includes a transmission side optical transmission apparatus having a transmitting unit configured to transmit optical signals of a predetermined number of differing wavelengths, and a processor configured to apply to the optical signals transmitted from the transmitting unit, a predetermined offset related to a tilt; and a reception side optical transmission apparatus having a receiving unit configured to receive the optical signals transmitted from the transmitting unit, a measuring unit configured to measure an optical signal count of the optical signals receivable by the receiving unit, and a notifying unit configured to give notification of the optical signal count measured by the measuring unit. The processor adjusts the offset in an increasing direction when the optical signal count notified by the notifying unit increases, and adjusts the offset in a decreasing direction when the optical signal count notified by the notifying unit decreases.

### CROSS REFERENCE TO RELATED APPLICATIONS

This application is based upon and claims the benefit of priority of the prior Japanese Patent Application No. 2013-118338, filed on Jun. 4, 2013, the entire contents of which are incorporated herein by reference.

### FIELD

The embodiments discussed herein are related to an optical transmission system, an optical transmission apparatus, and an optical transmission method.

### BACKGROUND

In a technique of transmitting optical signals, a wavelength division multiplex (WDM) mode is a communication mode of multiplexing optical signals of differing wavelengths to a single optical fiber. Although an optical transmission apparatus can transmit optical signals to different transmission destinations according to wavelength in the WDM mode, if optical output levels are amplified in an optical transmission apparatus relaying the optical signals, the number of times of relaying or the transmission distance may differ depending on the path of the optical signals. In this case, variation (hereinafter referred to as “tilt”) in the optical output level occurs between wavelengths. As a result, the tilt may not fall within a range of output level (dynamic range) of receivable optical signals at a reception side optical transmission apparatus. Therefore, to reduce the tilt, the optical transmission apparatus monitors the output level for each wavelength when relaying optical signals and feeds back the result for signal control so as to equalize the optical output levels.

According to a disclosed technique, in an optical communication mode of transmitting optical packets in a wavelength-multiplexed manner, the delay amount of optical packets assigned to each wavelength band is adjusted based on a skew amount of the optical packets assigned to each wavelength band (see, e.g., Japanese Laid-Open Patent Publication No. 2008-219166). In a wavelength multiplexing communication method, a pre-emphasis amount on the transmission side is set based on a measurement result of an optical signal-to-noise ratio in a disclosed technique (see, e.g., Japanese Laid-Open Patent Publication Nos. H8-321824 and H11-331127). A transmission level of an optical burst signal transmitted from a parent station to child stations is adjusted based on a reception level at the child stations in a disclosed technique (see, e.g., Japanese Laid-Open Patent Publication No. 11-136192).

The feedback control is effective in communication transmitting an optical signal to a different transmission destination according to wavelength. However, in the case of optical-packet time division multiplex transmission in which the same packet is transmitted through multiple optical signals having different wavelengths, since an optical packet signal is not a continuous signal, the optical signal-to-noise ratio cannot be measured on the reception side. Therefore, the feedback control described above does not work and tilt may occur in reception levels between wavelengths, causing a problem of inability to correct the tilt (perform tilt correction) on the transmission side. If the tilt correction cannot be performed, inclination may occur in reception levels between wavelengths and a reception level may not fall within a dynamic range on the reception side for a wavelength. Since a reception level not falling within the dynamic range on the reception side makes reception impossible, if even one wavelength results in a reception level not falling within the dynamic range on the reception side, this causes packet loss.

### SUMMARY

According to an aspect of an embodiment, an optical transmission system includes a transmission side optical transmission apparatus having a transmitting unit configured to transmit optical signals of a predetermined number of differing wavelengths, and a processor configured to apply to the optical signals transmitted from the transmitting unit, a predetermined offset related to a tilt; and a reception side optical transmission apparatus having a receiving unit configured to receive the optical signals transmitted from the transmitting unit, a measuring unit configured to measure an optical signal count of the optical signals receivable by the receiving unit, and a notifying unit configured to give notification of the optical signal count measured by the measuring unit. The processor adjusts the offset in an increasing direction when the optical signal count notified by the notifying unit increases, and adjusts the offset in a decreasing direction when the optical signal count notified by the notifying unit decreases.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram of a first example of an optical transmission system and an optical transmission apparatus according to an embodiment;

FIG. 2 is a diagram of an example of signal flow in the optical transmission system and the optical transmission apparatus depicted in FIG. 1;

FIG. 3 is an example of a configuration of hardware implementing an offset unit in the optical transmission apparatus depicted in FIG. 1;

FIG. 4 is a diagram of an example of the optical transmission method according the embodiment;

FIG. 5 is a diagram of a second example of the optical transmission system according to the embodiment;

FIG. 6 is a diagram for explaining how the optical transmission apparatus transmits a packet;

FIG. 7 is a diagram of tilt accumulation when optical signals are transmitted without an offset related to the tilt on a transmission side;

FIG. 8 is a diagram depicting cancellation of the offset related to the tilt applied on the transmission side;

FIG. 9 is a diagram of a second example of the optical transmission apparatus according to the embodiment;

FIG. 10 is a diagram of an example of a test packet in which information of levels of wavelengths is written;

FIG. 11 is a diagram of a first example of a procedure, at the optical transmission apparatus according to the embodiment, for adjusting the offset related to tilt;

FIG. 12 is a diagram continued from FIG. 11;

FIG. 13 is a diagram of a first specific example of a procedure of adjusting the offset related to tilt;

FIG. 14 is a diagram continued from FIG. 13;

FIG. 15 is a diagram of a second specific example of the procedure of adjusting the offset related to tilt;

FIG. 16 is a diagram continued from FIG. 15;

FIG. 17 is a diagram continued from FIG. 16;

FIG. 18 is a diagram of a third example of the optical transmission apparatus according to the embodiment;

FIG. 19 is a diagram of an example of a frame in which information of levels of wavelengths is written;

FIG. 20 is a diagram of a second example of the procedure, at the optical transmission apparatus according to the embodiment, for adjusting the offset related to tilt;

FIG. 21 is a diagram of a third specific example of the procedure of adjusting the offset related to tilt; and

FIG. 22 is a diagram continued from FIG. 21.

### DESCRIPTION OF EMBODIMENTS

Preferred embodiments of an optical transmission system, an optical transmission apparatus, and an optical transmission method will now be described in detail with reference to the accompanying drawings. In the following description, the same constituent elements are denoted by the same reference numerals and redundant explanation will be omitted.

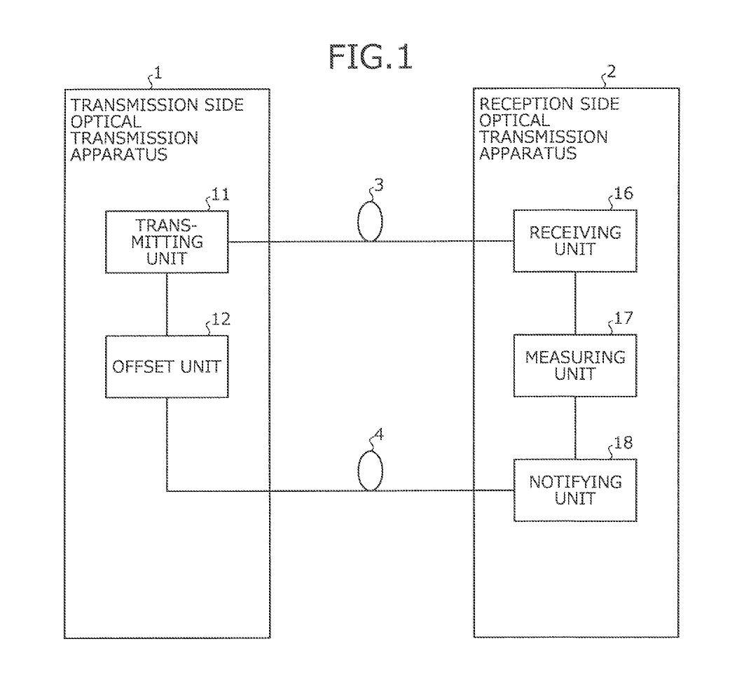

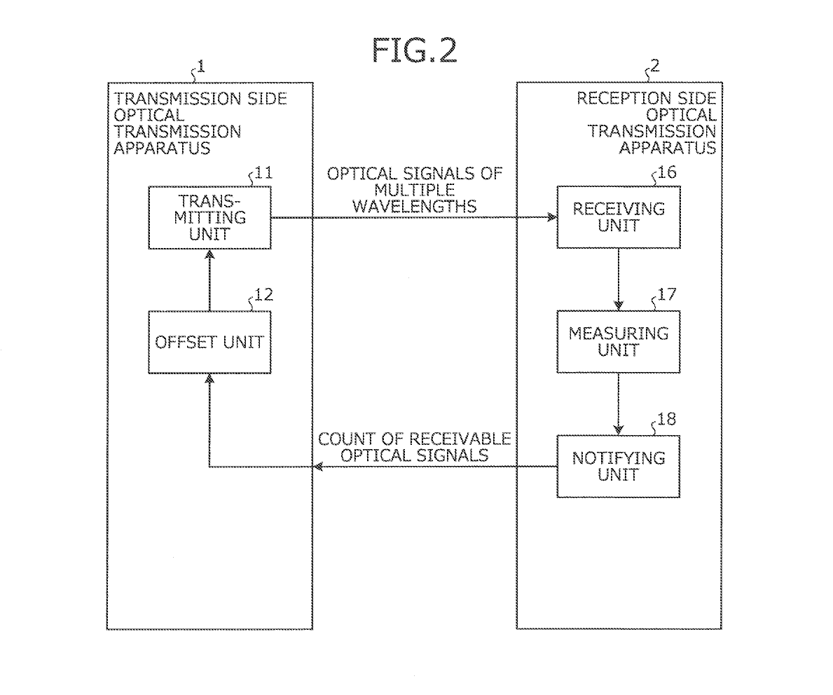

FIG. 1 is a diagram of a first example of the optical transmission system and the optical transmission apparatus according to an embodiment. FIG. 2 is a diagram of an example of signal flow in the optical transmission system and the optical transmission apparatus depicted in FIG. 1. As depicted in FIGS. 1 and 2, the optical transmission system has a transmission side optical transmission apparatus 1, a reception side optical transmission apparatus 2, and an optical transmission path 3. An optical relay apparatus (not depicted) relaying and amplifying optical signals may be connected in the optical transmission path 3. An optical fiber is an example of the optical transmission path 3.

The transmission side optical transmission apparatus 1 has a transmitting unit 11 and an offset unit 12. The transmitting unit 11 transmits optical signals of a predetermined number of different wavelengths λ₁, . . . , λₙ to the reception side optical transmission apparatus 2. It is noted that n is an integer greater than or equal to two. The offset unit 12 is connected to the transmitting unit 11. The offset unit 12 applies a predetermined offset related to a tilt to the optical signals transmitted from the transmitting unit 11.

The offset unit 12 adjusts the offset in the increasing direction if an optical signal count notified by the reception side optical transmission apparatus 2 increases. The offset unit 12 adjusts the offset in the decreasing direction if the optical signal count notified by the reception side optical transmission apparatus 2 decreases. The offset unit 12 may be implemented by a processor executing a program implementing a process of adjusting the offset based on the optical signal count notified by the reception side optical transmission apparatus 2.

The reception side optical transmission apparatus 2 has a receiving unit 16, a measuring unit 17, and a notifying unit 18. The receiving unit 16 is connected, via the optical transmission path 3, to the transmitting unit 11 of the transmission side optical transmission apparatus 1. The receiving unit 16 receives the optical signals transmitted from the transmitting unit 11 of the transmission side optical transmission apparatus 1. The measuring unit 17 is connected to the receiving unit 16. The measuring unit 17 measures a count of the optical signals receivable by the receiving unit 16 based on the optical signals received by the receiving unit 16.

The notifying unit 18 is connected to the measuring unit 17. The notifying unit 18 notifies the transmission side optical transmission apparatus 1 of the optical signal count measured by the measuring unit 17. The notifying unit 18 is connected to an optical transmission path 4 and may notify the transmission side optical transmission apparatus 1 of the optical signal count measured by the measuring unit 17, via this optical transmission path 4. An optical fiber is an example of the optical transmission path 4.

A hardware configuration in a case of implementing the offset unit 12 by a processor executing a program will be described.

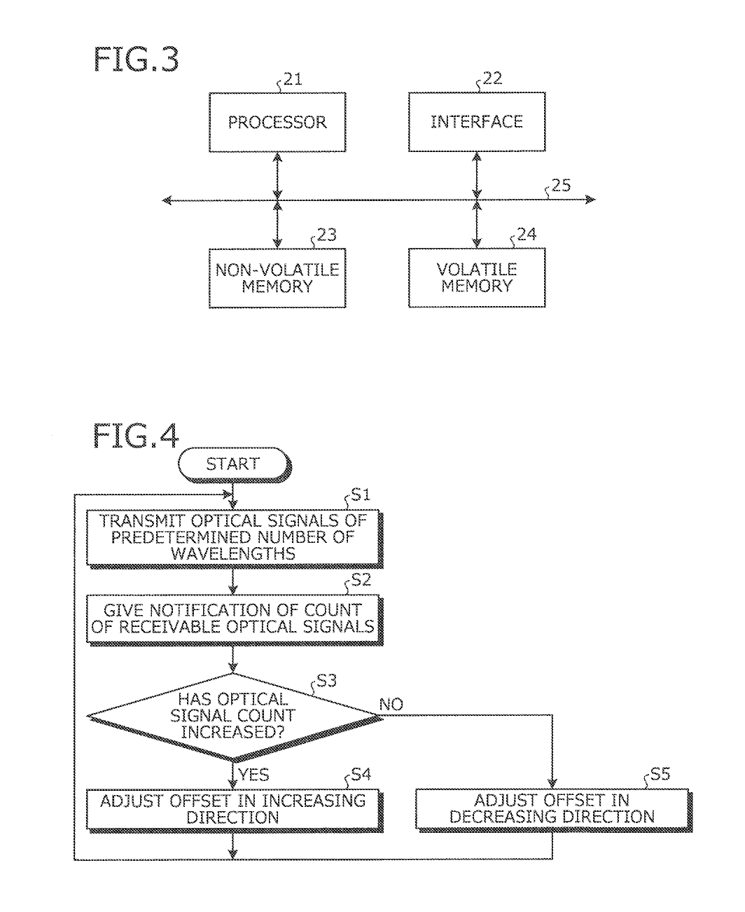

FIG. 3 is an example of a configuration of hardware implementing the offset unit in the optical transmission apparatus depicted in FIG. 1. As depicted in FIG. 3, the hardware implementing the offset unit 12 has, for example a processor 21, an interface 22, non-volatile memory 23, and volatile memory 24. The processor 21, the interface 22, the non-volatile memory 23, and the volatile memory 24 may be connected to a bus 25.

The processor 21 processes the program implementing the process of adjusting the offset based on the optical signal count notified by the reception side optical transmission apparatus 2. As a result, the offset unit 12 depicted in FIG. 1 is implemented. An example of the processor 21 may be, for example, a central processing unit (CPU), an application specific integrated circuit (ASIC), or a programmable logic device such as a field programmable gate array (FPGA), or a combination thereof.

The non-volatile memory 23 stores a boot program and the program implementing the process of adjusting the offset based on the optical signal count notified by the reception side optical transmission apparatus 2. The non-volatile memory 23 may store information of an optimal offset obtained by executing the program implementing the process of adjusting the offset based on the optical signal count notified by the reception side optical transmission apparatus 2. If the processor 21 is a programmable logic device, the non-volatile memory 23 may store circuit information of the programmable logic device.

An example of the non-volatile memory 23 may be rewritable read only memory (ROM) such as electrically erasable programmable read only memory (EEPROM) or a flash memory. Alternatively, an example of the non-volatile memory 23 may be a combination of the rewritable ROM and a mask ROM.

If the rewritable ROM and the mask ROM are included, the mask ROM may store the boot program and the program implementing the process of adjusting the offset based on the optical signal count notified by the reception side optical transmission apparatus 2. The rewritable ROM may store the information of the optimal offset obtained by executing the program implementing the process of adjusting the offset based on the optical signal count notified by the reception side optical transmission apparatus 2.

The volatile memory 24 is used a work area of the processor 21. The volatile memory 24 retains the program read from the non-volatile memory 23, circuit information, and the information of the optimal offset. An example of the volatile memory 24 may be RAM such as a dynamic random access memory (DRAM) and a static random access memory (SRAM).

The interface 22 is responsible for input of the information of the optical signal count notified by the reception side optical transmission apparatus 2 and output of the information of the offset.

FIG. 4 is a diagram of an example of the optical transmission method according the embodiment. The optical transmission method depicted in FIG. 4 may be performed in the optical transmission system depicted in FIG. 1. In the description of this embodiment, the optical transmission method depicted in FIG. 4 is performed in the optical transmission system depicted in FIG. 1.

The transmission side optical transmission apparatus 1 causes the offset unit 12 to apply a predetermined offset related to a tilt of the optical signals of a predetermined number of different wavelengths transmitted from the transmitting unit 11. The transmission side optical transmission apparatus 1 causes the transmitting unit 11 to transmit the optical signals of the predetermined number of different wavelengths (step S1).

The reception side optical transmission apparatus 2 causes the receiving unit 16 to receive the optical signals transmitted from the transmission side optical transmission apparatus 1. The reception side optical transmission apparatus 2 causes the measuring unit 17 to measure the count of receivable optical signals. The reception side optical transmission apparatus 2 causes the notifying unit 18 to notify the transmission side optical transmission apparatus 1 of the optical signal count measured by the measuring unit 17 (step S2).

The transmission side optical transmission apparatus 1 receives the optical signal count notified by the reception side optical transmission apparatus 2 and determines whether the optical signal count notified by the reception side optical transmission apparatus 2 has increased (step S3). If the optical signal count notified by the reception side optical transmission apparatus 2 has increased (step S3: YES), the transmission side optical transmission apparatus 1 causes the offset unit 12 to adjust the offset for the optical signals of the predetermined number of different wavelengths transmitted from the transmitting unit 11, in the increasing direction (step S4). Returning to step S1, the transmission side optical transmission apparatus 1 again transmits optical signals of the predetermined number of different wavelengths with the offset applied.

On the other hand, if the optical signal count notified by the reception side optical transmission apparatus 2 has decreased (step S3: NO), the transmission side optical transmission apparatus 1 causes the offset unit 12 to adjust the offset for the optical signals of the predetermined number of different wavelengths transmitted from the transmitting unit 11, in the decreasing direction (step S5). Returning to step S1, the transmission side optical transmission apparatus 1 again transmits optical signals of the predetermined number of different wavelengths with the offset applied.

By repeating the steps S1 to S5 described above, the offset is adjusted such that a tilt amount at the reception side optical transmission apparatus 2 becomes optimal. When the offset is adjusted such that the tilt amount becomes optimal, for example, the count of optical signal receivable by the reception side optical transmission apparatus 2 becomes identical to the number of optical signals transmitted by the transmission side optical transmission apparatus 1.

According to the optical transmission system and the optical transmission apparatus depicted in FIG. 1 or the optical transmission method depicted in FIG. 4, the offset related to the tilt is adjusted at the transmission side optical transmission apparatus 1 based on the count of optical signals receivable by the reception side optical transmission apparatus 2 among the optical signals of the predetermined number of different wavelengths transmitted by the transmission side optical transmission apparatus 1. For example, the offset is adjusted at the transmission side optical transmission apparatus 1 such that the count of optical signal receivable by the reception side optical transmission apparatus 2 becomes identical to the number of wavelengths of the optical signals transmitted by the transmission side optical transmission apparatus 1. Therefore, the tilt correction can be performed at the transmission side optical transmission apparatus 1 such that all the optical signals of the different wavelengths transmitted by the transmission side optical transmission apparatus 1 can be received by the reception side optical transmission apparatus 2.

The optical transmission system depicted in FIG. 1 or the optical transmission method depicted in FIG. 4 is applicable to optical-packet time division multiplex transmission system and method. Description will hereinafter be made of a case of applying the optical transmission system depicted in FIG. 1 or the optical transmission method depicted in FIG. 4 to an optical-packet time division multiplex transmission system and method.

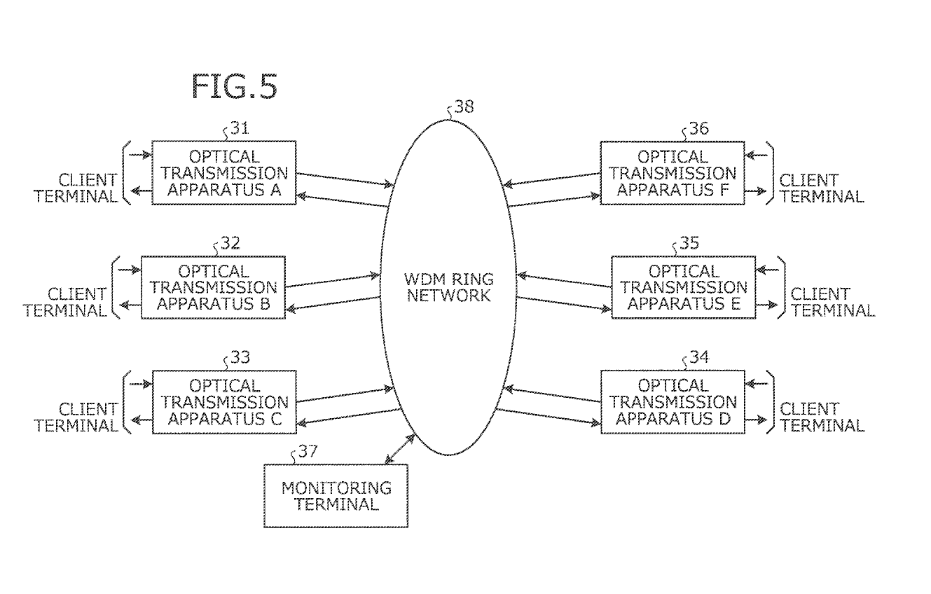

FIG. 5 is a diagram of a second example of the optical transmission system according to the embodiment. As depicted in FIG. 5, an optical-packet time division multiplex transmission system has multiple, for example, in the depicted example, six, optical transmission apparatuses 31 to 36 from A to F and a monitoring terminal 37 connected to a WDM ring network 38.

Each of the optical transmission apparatuses 31 to 36 disassembles a packet delivered from each of respectively connected client terminals (not depicted) into multiple packet signals of electronic signals, and assigns the multiple packet signals to multiple optical signals having different wavelengths for transmission to the WDM ring network 38. Each of the optical transmission apparatuses 31 to 36 is an example of the transmission side optical transmission apparatus.

Each of the optical transmission apparatuses 31 to 36 receives and converts multiple optical signals having different wavelengths from the WDM ring network 38 into electronic signals, assembles the original packet from multiple packet signals assigned to the optical signals, and delivers the packet to each of the respectively connected client terminals. Each of the optical transmission apparatuses 31 to 36 is an example of the reception side optical transmission apparatus.

The optical signals of the packet transmitted from the optical transmission apparatus A31 to the optical transmission apparatus B32 arrives at the optical transmission apparatus B32 via the WDM ring network 38. Each of the optical transmission apparatuses 31 to 36 acts as an optical relay apparatus relaying optical signals of a packet transmitted from another one of the optical transmission apparatuses 31 to 36 to yet another one of the optical transmission apparatuses 31 to 36. When acting as the optical relay apparatus, each of the optical transmission apparatuses 31 to 36 uses a built-in optical switch (not depicted) to return the optical signals received from the WDM ring network 38 and uses a built-in amplifier (not depicted) to amplify the optical signals before transmission to the WDM ring network 38.

For example, optical signals of a packet transmitted from the optical transmission apparatus A31 to the optical transmission apparatus C33 may arrive at the optical transmission apparatus C33 via the WDM ring network 38, the optical transmission apparatus B32, and the WDM ring network 38. Optical signals of a packet transmitted from the optical transmission apparatus A31 to the optical transmission apparatus D34 may arrive at the optical transmission apparatus D34 via the WDM ring network 38, the optical transmission apparatus B32, the WDM ring network 38, the optical transmission apparatus C33, and the WDM ring network 38.

The monitoring terminal 37 monitors the optical transmission apparatuses 31 to 36. For example, in a maintenance mode of adjusting the offset related to the tilt described later, the monitoring terminal 37 puts the transmission side optical transmission apparatus and the reception side optical transmission apparatus subjected to the offset adjustment into an operation state enabling transmission and reception of optical signals, and puts an optical transmission apparatus therebetween into an operation state of amplifying and relaying the optical signals. The other optical transmission apparatuses are put into an operation suspension state by the monitoring terminal 37. Therefore, in the maintenance mode of adjusting the offset related to the tilt, the monitoring terminal 37 puts the transmission side optical transmission apparatus and the reception side optical transmission apparatus subjected to the offset adjustment into a state of occupying the WDM ring network 38.

In the maintenance mode, the monitoring terminal 37 monitors whether a loss of light (LOL) or a loss of signal (LOS) occurs in the optical transmission apparatuses 31 to 36. The monitoring terminal 37 causes an optical transmission apparatus subjected to measurement to transmit a test packet such that the reception side optical transmission apparatuses receive the test packet, so as to confirm that neither the LOL nor the LOS occurs. The maintenance mode of adjusting the offset related to the tilt is implemented when an optical transmission system is constructed or if an optical transmission apparatus or the number of wavelengths is increased or decreased in the optical transmission system being operated.

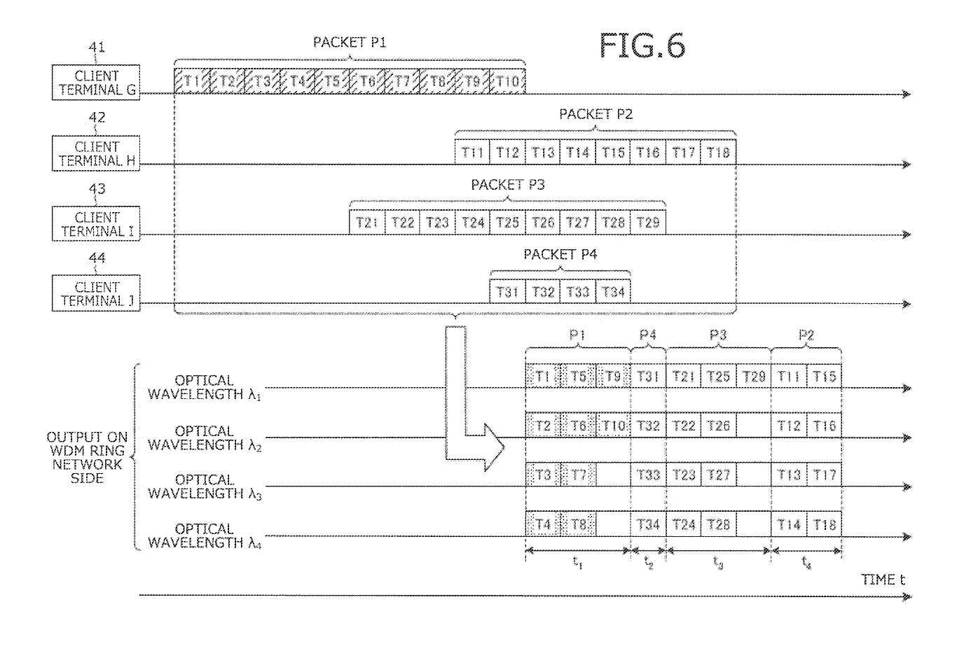

FIG. 6 is a diagram for explaining how the optical transmission apparatus transmits a packet. As depicted in FIG. 6, it is assumed that a packet P1 is made up of ten optical signals T1 to T10, for example. The packet P1 (shaded portions of FIG. 6) transmitted from a client terminal G41 is disassembled into four signal groups (portions indicated by dots of FIG. 6), for example. Each of the four signal groups is optoelectronically converted and output toward the WDM ring network at a corresponding wavelength among multiple wavelengths λ₁ to λ₄. The four signal groups are integrated again and received as one packet on the reception side. A packed P2 transmitted from a client terminal H42, a packed P3 transmitted from a client terminal I43, and a packed P4 transmitted from a client terminal J44 are also respectively disassembled into multiple signals and transmitted through optical signals having multiple wavelengths.

The transmission mode as described above performed by the optical transmission apparatuses will hereinafter be referred to as “optical burst transmission”. In a case other than the optical burst transmission, since the optical signals T1 to T10 are serially and sequentially transmitted, a longer time is required from the input of a packet until the lines of the wavelengths λ₁ to λ₄ are opened. As a result, the period of occupation of a network line by the client terminals 41 to 44 may become longer. In contrast, in the optical burst transmission, as depicted in FIG. 6, the optical signals T1 to T10 are transmitted in parallel at the respective wavelengths λ₁ to λ₄. Therefore, the transmission time per packet is a time t₁ to t₄ (time t₁ in the case of the packet P1) until transmission of at most three signals (optical signals T1, T5, and T9 in the case of the packet P1) are completed. As a result, the line occupation time is significantly reduced.

As described above, each of the optical transmission apparatuses 31 to 36 acts as an optical relay apparatus to relay the optical signals of a packet transmitted from another one of the optical transmission apparatuses 31 to 36 to yet another one of the optical transmission apparatuses 31 to 36. During relay, a tilt occurs between wavelengths consequent to linear amplifiers built into the optical transmission apparatuses 31 to 36. This tilt occurs and accumulates each time the optical signals pass through the relaying optical transmission apparatus 31 to 36.

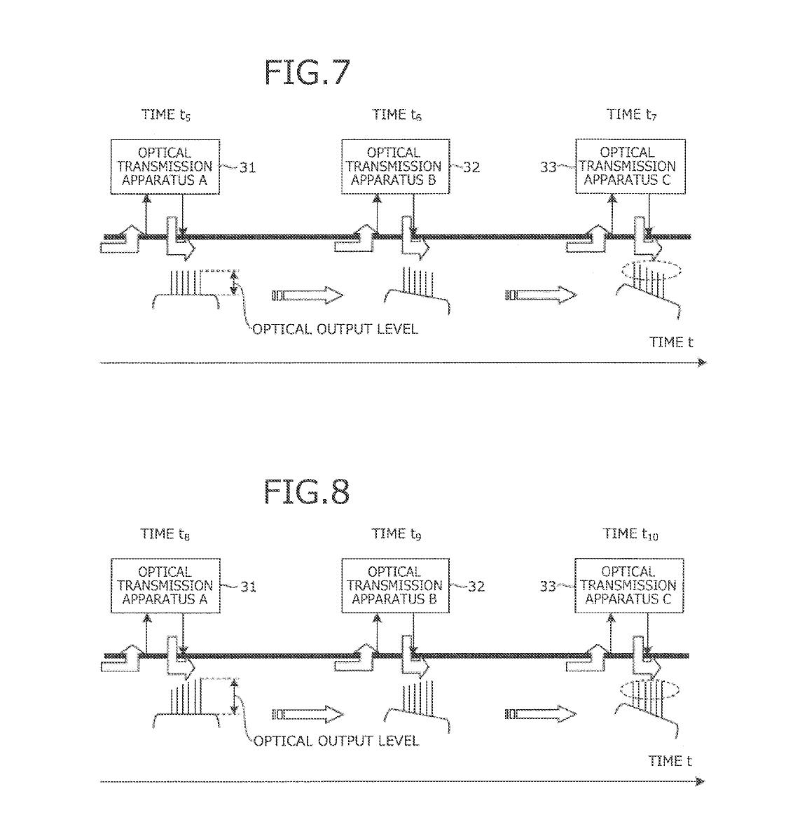

FIG. 7 is a diagram of tilt accumulation when optical signals are transmitted without an offset related to the tilt on the transmission side. As depicted in FIG. 7, at time t₅, for example, optical signals of a packet transmitted from the optical transmission apparatus A31 via optical burst transmission are in a state in which output levels of respective wavelengths are equal to each other (a tilt zero state). However, for example, as the optical signals of the packet pass through the optical transmission apparatus B32, a tilt occurs due to the effect of the linear amplifier at time t₆ and therefore, the output levels of the optical signals decrease as time t progresses. As a result, the output levels of the optical signals having longer wavelengths with higher attenuation rates (on the right side) are inclined downward in FIG. 7. At time t₇, for example, since the optical signals of the packet are relayed through the optical transmission apparatus C33, the accumulation of the tilt occurs and further variations occur in the output levels of respective wavelengths of the optical signals (a portion encompassed by a broken line in FIG. 7). Thus, a dynamic range wider than a normal dynamic range (e.g., −20 dBm to +4 dBm) is required to properly receive the packet on the reception side.

In this regard, if the optical signals are transmitted after the offset related to the tilt is applied on the transmission side as in this example, the offset applied on the transmission side is canceled by the tilt occurring when optical signals pass through the optical transmission apparatuses.

FIG. 8 is a diagram depicting cancellation of the offset related to the tilt applied on the transmission side. As depicted in FIG. 8, at time t₈, for example, optical signals of a packet transmitted from the optical transmission apparatus A31 via optical burst transmission are transmitted at optical output levels to which offset is applied according to the tilt amount of wavelengths, occurring up to a destination. The optical signals of the packet having the tilt of “zero” at time t₈ are affected by a tilt occurring when the optical signals pass through the optical transmission apparatus B32, for example, and enter a state depicted at time t₉. At this time point, the occurrence of the tilt makes the output levels of the optical signals lower in the forward direction of time t. However, since the offset is applied in advance to the output levels of the optical signals in, for example, the optical transmission apparatus A31, the effect of the tilt is limited as compared to a case without the offset. Although the accumulation of the tilt occurs at time t_{ic} due to relaying of the optical signals of the packet through, for example, the optical transmission apparatus C33, the variations of the output levels due to the tilt (a portion encompassed by a broken line in FIG. 8) are canceled by the amplification by the linear amplifier corresponding to the wavelengths of the optical signals. Thus, since the output levels of the optical signals of the packet become substantially identical on the reception side, the levels of the wavelengths become constant. As a result, the optical transmission device on the reception side can properly receive the packet within the minimum required dynamic range.

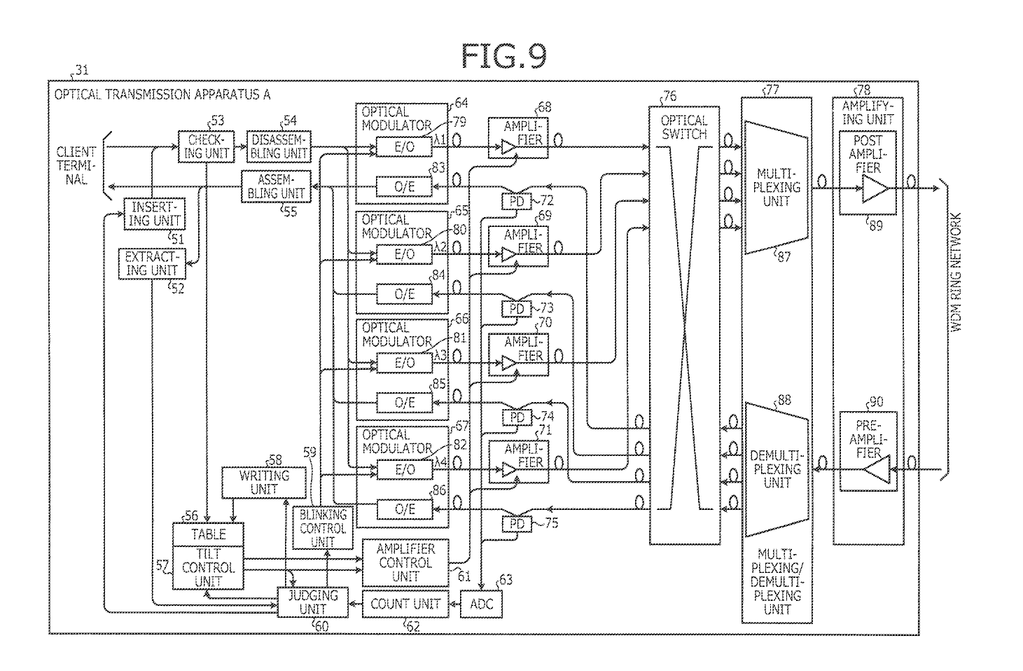

FIG. 9 is a diagram of a second example of the optical transmission apparatus according to the embodiment. The optical transmission apparatus depicted in FIG. 9 may be an example of the optical transmission apparatuses 31 to 36 in the optical transmission system depicted in FIG. 5. In the description of this example, the optical transmission apparatus depicted in FIG. 9 is the optical transmission apparatus A31 in the optical transmission system depicted in FIG. 5. The optical transmission apparatuses 32 to 36 are the same as the optical transmission apparatus A31 and therefore, will not be described. In the maintenance mode of adjusting the offset related to the tilt, each of the optical transmission apparatuses 31 to 36 may act as the transmission side optical transmission apparatus or may act as the reception side optical transmission apparatus.

As depicted in FIG. 9, the optical transmission apparatus A31 has an inserting unit 51, an extracting unit 52, a checking unit 53, a disassembling unit 54, an assembling unit 55, a table 56, a tilt control unit 57, a writing unit 58, a blinking control unit 59, a judging unit 60, an amplifier control unit 61, a count unit 62, and an analog-to-digital converter (ADC) 63. The optical transmission apparatus A31 has optical modulators 64 to 67, amplifiers 68 to 71, photodiodes (PDs) 72 to 75, an optical switch 76, a multiplexing/demultiplexing unit 77, and an amplifying unit 78. The optical modulators 64 to 67 respectively have E/O converters 79 to 82 and 0/E converters 83 to 86. The multiplexing/demultiplexing unit 77 has a multiplexing unit 87 and a demultiplexing unit 88. The amplifying unit 78 has a postamplifier 89 and a preamplifier 90.

The case of the optical transmission apparatus A31 acting as the transmission side optical transmission apparatus and the case of the optical transmission apparatus A31 acting as the reception side optical transmission apparatus may hereinafter be abbreviated as a “transmission side apparatus case” and a “reception side apparatus case”, respectively. If it is not necessary to make a distinction between the cases of the optical transmission apparatus A31 acting as the transmission side optical transmission apparatus and the reception side optical transmission apparatus in the description, no particular indication will be made.

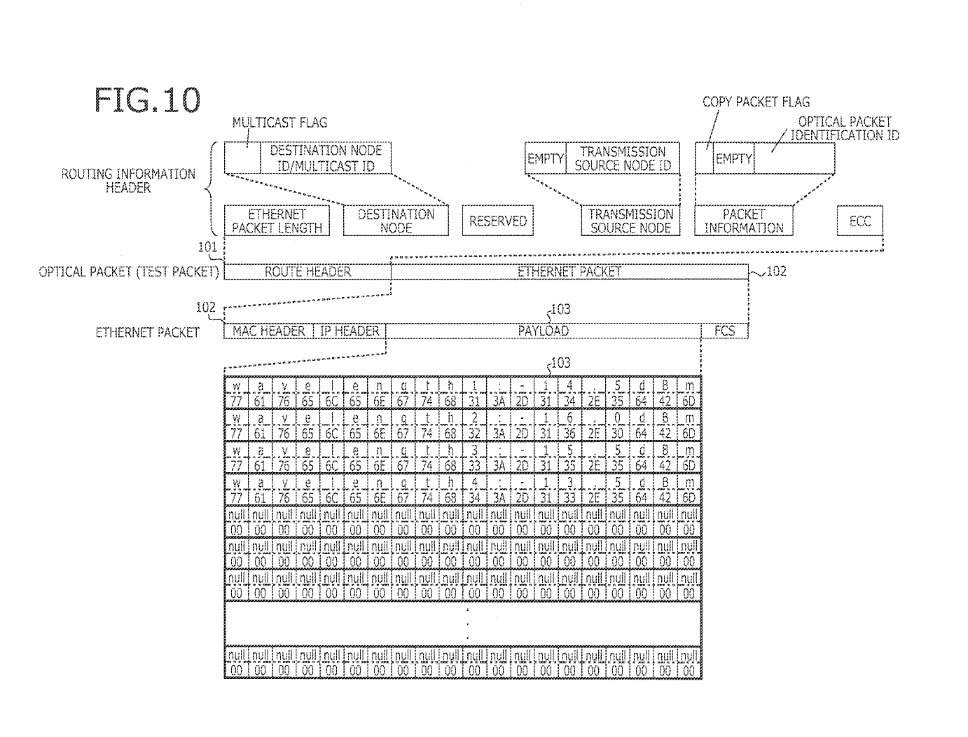

The inserting unit 51 is connected to the judging unit 60. In the transmission side apparatus case, the inserting unit 51 sequentially outputs test packets to the checking unit 53. In the reception side apparatus case, the inserting unit 51 outputs to the checking unit 53, a test packet in which information of levels of wavelengths supplied from the judging unit 60 is written. FIG. 10 depicts an example of the test packet in which information of levels of wavelengths is written.

The checking unit 53 is connected to the inserting unit 51 and a client terminal not depicted. The checking unit 53 checks a destination of a test packet output from the inserting unit 51. The checking unit 53 supplies the table 56 with the information of the destination of the test packet and outputs the test packet to the disassembling unit 54. In a normal operation mode, the checking unit 53 checks a destination of a packet input from the client terminal, supplies the table 56 with the information of the destination of the packet, and outputs the packet to the disassembling unit 54.

The table 56 is connected to the checking unit 53 and the writing unit 58. The table 56 stores the offsets corresponding to the destinations of packets. The table 56 supplies the amplifier control unit 61 with information of the offset corresponding to the destination supplied from the checking unit 53.

The writing unit 58 is connected to the judging unit 60. In the transmission side apparatus case, when a write instruction is received from the judging unit 60, the writing unit 58 writes the offset at this time point into the table 56.

The amplifier control unit 61 is connected to the table 56 and the tilt control unit 57. The amplifier control unit 61 controls the amplifiers 68 to 71 based on the offset supplied from the table 56. In the transmission side apparatus case, the amplifier control unit 61 controls the amplifiers 68 to 71 based on the offset instructed by the tilt control unit 57.

The tilt control unit 57 is connected to the judging unit 60. In the transmission side apparatus case, when an offset change instruction is received from the judging unit 60, the tilt control unit 57 controls the offset according to contents of the instruction.

The disassembling unit 54 is connected to the checking unit 53. The disassembling unit 54 disassembles a test packet output from the checking unit 53 into multiple, for example, in the example depicted in FIG. 9, four, parallel data and outputs the respective data to the E/O converters 79 to 82 of the optical modulators 64 to 67 of the corresponding wavelengths.

The E/O converters 79 to 82 are connected to the disassembling unit 54 and the blinking control unit 59. The E/O converters 79 to 82 convert the data output from the disassembling unit 54 into optical signals. In the reception side apparatus case, the E/O converters 79 to 82 blink under the control of the blinking control unit 59.

The amplifiers 68 to 71 are connected to the E/O converters 79 to 82 and the amplifier control unit 61. In the transmission side apparatus case, the amplifiers 68 to 71 are controlled by the amplifier control unit 61 to amplify the optical signals output from the E/O converters 79 to 82. In the reception side apparatus case, the amplifiers 68 to 71 are controlled by the amplifier control unit 61 to amplify the optical signals or the blinking lights output from the E/O converters 79 to 82.

The optical switch 76 is connected to the amplifiers 68 to 71 and the demultiplexing unit 88 of the multiplexing/demultiplexing unit 77. In the transmission side apparatus case, the optical switch 76 sets transmission destinations and transmission paths according to the destination of the packet to output to the multiplexing unit 87 of the multiplexing/demultiplexing unit 77, the optical signals output from the amplifiers 68 to 71. In the transmission side apparatus case, the optical switch 76 outputs the optical signals or the blinking lights output from the demultiplexing unit 88 to the PDs 72 to 75 and the O/E converters 83 to 86 of the optical modulators 64 to 67 according to wavelength.

In the reception side apparatus case, the optical switch 76 sets transmission destinations and transmission paths according to the destination of the packet to output to the multiplexing unit 87 of the multiplexing/demultiplexing unit 77, the optical signals or the blinking lights output from the amplifiers 68 to 71. In the reception side apparatus case, the optical switch 76 outputs the optical signals output from the demultiplexing unit 88 to the PDs 72 to 75 and the O/E converters 83 to 86 of the optical modulators 64 to 67 according to wavelength.

The multiplexing unit 87 is connected to the optical switch 76. In the transmission side apparatus case, the multiplexing unit 87 multiplexes and outputs to the postamplifier 89 of the amplifying unit 78, the optical signals having different wavelengths output from the optical switch 76. In the reception side apparatus case, the multiplexing unit 87 multiplexes and outputs the optical signals having different wavelengths or the blinking lights output from the optical switch 76 to the postamplifier 89 of the amplifying unit 78.

The postamplifier 89 is connected to the multiplexing unit 87 and the WDM ring network 38 not depicted. In the transmission side apparatus case, the postamplifier 89 amplifies and outputs to the WDM ring network 38, the optical signal output from the multiplexing unit 87. In the reception side apparatus case, the postamplifier 89 amplifies and outputs to the WDM ring network 38, the optical signal or the blinking light output from the multiplexing unit 87.

The preamplifier 90 is connected to the WDM ring network 38 not depicted. In the transmission side apparatus case, the preamplifier 90 receives, amplifies, and outputs to the demultiplexing unit 88 of the multiplexing/demultiplexing unit 77, the optical signal or the blinking light input from the WDM ring network 38. In the reception side apparatus case, the preamplifier 90 receives, amplifies, and outputs to the demultiplexing unit 88 of the multiplexing/demultiplexing unit 77, the optical signal input from the WDM ring network 38.

The demultiplexing unit 88 is connected to the preamplifier 90. In the transmission side apparatus case, the demultiplexing unit 88 demultiplexes the optical signal or the blinking light output from the preamplifier 90, into optical signals of respective wavelengths and outputs the optical signals to the optical switch 76. In the reception side apparatus case, the demultiplexing unit 88 demultiplexes the optical signal output from the preamplifier 90, into optical signals of respective wavelengths and outputs the optical signals to the optical switch 76.

The PDs 72 to 75 are connected to the optical switch 76. In the transmission side apparatus case, the PDs 72 to 75 measure according to wavelength, the levels of the optical signals or the blinking lights output from the optical switch 76, convert the levels into electronic signals that correspond to the levels of the optical signals or the blinking lights, and output the electronic signals to the ADC 63. In the reception side apparatus case, the PDs 72 to 75 measure according to wavelength, the levels of the optical signals output from the optical switch 76, convert the levels into electronic signals that correspond to the levels of the optical signals, and output the electronic signals to the ADC 63.

The ADC 63 is connected to the PDs 72 to 75. In the transmission side apparatus case, the ADC 63, based on the output signals of the PDs 72 to 75, sums the levels of the optical signals or the blinking light of the respective wavelengths (measured by the PDs 72 to 75), converts the levels into digital signals, and outputs the digital signals to the count unit 62. In the reception side apparatus case, the ADC 63, based on the output signals of the PDs 72 to 75, sums the levels of the optical signals of the respective wavelengths measured by the PDs 72 to 75, converts the levels into digital signals, and outputs the digital signals to the count unit 62.

The count unit 62 is connected to the ADC 63. In the transmission side apparatus case, the count unit 62 counts the number of times the light from the reception side optical transmission apparatus, via the WDM ring network 38 (not depicted), blinks, based on the level output from the ADC 63 and notifies the judging unit 60 of information of the number of times the light blinks. In the reception side apparatus case, the count unit 62, based on the level output from the ADC 63, counts and notifies the judging unit 60 of the number of wavelengths of the optical signals at levels receivable by the O/E converters 83 to 86 of the optical modulators 64 to 67. In the reception side apparatus case, the count unit 62 counts information of a level of an optical signal for each summed wavelength, based on the level output from the ADC 63 and notifies the judging unit 60 of the level of each wavelength.

The O/E converters 83 to 86 are connected to the optical switch 76. The O/E converters 83 to 86 convert the optical signals output from the optical switch 76, into electronic signals, and output the electronic signals.

The assembling unit 55 is connected to the O/E converters 83 to 86. The assembling unit 55 assembles the electronic signals output from the O/E converters 83 to 86 into a packet and outputs the packet. The assembling unit 55 is also connected to the client terminal not depicted. In the normal operation mode, the assembling unit 55 outputs the assembled packet to the client terminal.

The extracting unit 52 is connected to the assembling unit 55. In the transmission side apparatus case, the extracting unit 52 extracts from the packet output from the assembling unit 55, level information of wavelengths and notifies the judging unit 60 of the extracted level information.

The judging unit 60 is connected to the tilt control unit 57, the count unit 62, and the extracting unit 52. In the transmission side apparatus case, the judging unit 60 compares the number of times the light blinks notified by the count unit 62 and the number of wavelengths of the optical signals transmitted by the apparatus of the judging unit 60. As a result of the comparison, if the number of times the light blinks is not identical to the number of the transmission wavelengths of the apparatus and if this is a first comparison after a transition to the maintenance mode of adjusting the offset related to the tilt, the judging unit 60 outputs to the tilt control unit 57, an offset change instruction to change the offset toward either a shorter wavelength or a longer wavelength. It is preliminarily determined whether the offset is changed toward a shorter wavelength or a longer wavelength.

If the number of times the light blinks is not identical to the number of the transmission wavelengths of the apparatus and if this is a second or later comparison after a transition to the maintenance mode of adjusting the offset related to the tilt, the judging unit 60 obtains information of the offset at this time point from the tilt control unit 57. The judging unit 60 outputs to the tilt control unit 57, an offset change instruction to change the offset such that the number of times the light blinks notified by the count unit 62 increases. For example, in the second or later comparison, if the number of times the blinks notified by the count unit 62 increases as compared to the previous comparison, the judging unit 60 may change the offset in the increasing direction, and if the number of times the light blinks decreases as compared to the previous comparison, the judging unit 60 may change the offset in the decreasing direction.

If the number of times the light blinks is identical to the number of the transmission wavelengths of the apparatus, the judging unit 60 outputs to the tilt control unit 57, an offset change instruction to change the offset in the direction of reducing variation of levels between the wavelengths notified by the extracting unit 52. If the variation of levels between the wavelengths notified by the extracting unit 52 becomes less than or equal to a target value, the judging unit 60 outputs a write instruction to the writing unit 58. The target value is preset in the judging unit 60.

In the reception side apparatus case, the judging unit 60 writes the number of times of the light blinks, into the blinking control unit 59 based on information of the count of the number of wavelengths notified by the count unit 62. In the reception side apparatus case, the judging unit 60 outputs to the blinking control unit 59, a stop instruction to stop the blinking of the E/O converters 79 to 82 of the optical modulators 64 to 67 and notifies the inserting unit 51 of the level of each wavelength notified by the count unit 62.

The blinking control unit 59 is connected to the judging unit 60. The blinking control unit 59 causes the E/O converters 79 to 82 of the optical modulators 64 to 67 to blink the number of times written by the judging unit 60.

In the configuration when the optical transmission apparatus A31 acts as the transmission side optical transmission device, the offset unit may include the tilt control unit 57, the judging unit 60, the amplifier control unit 61, the count unit 62, the ADC 63, and the PDs 72 to 75. The transmitting unit may include the inserting unit 51, the checking unit 53, the disassembling unit 54, the E/O converters 79 to 82 of the optical modulators 64 to 67, and the postamplifier 89 of the amplifying unit 78.

In the configuration when the optical transmission apparatus A31 acts as the reception side optical transmission device, the receiving unit may include the preamplifier 90 of the amplifying unit 78, the demultiplexing unit 88 of the multiplexing/demultiplexing unit 77, the PDs 72 to 75, and the O/E converters 83 to 86 of the optical modulators 64 to 67. The measuring unit may include the ADC 63 and the count unit 62. The notifying unit may include the judging unit 60, the blinking control unit 59, the E/O converters 79 to 82 of the optical modulators 64 to 67, the amplifiers 68 to 71, the optical switch 76, the multiplexing unit 87 of the multiplexing/demultiplexing unit 77, and the postamplifier 89 of the amplifying unit 78.

In the optical transmission apparatus A31, the table 56 may be stored in rewritable ROM such as EEPROM and flash memory. A boot program may be stored in non-volatile memory such as rewritable ROM and mask ROM. The judging unit 60 may be implemented by a CPU executing the program implementing the process of adjusting the offset, for example. The program implementing the process of adjusting the offset may be stored in non-volatile memory such as rewritable ROM and mask ROM. The CPU may use volatile memory such as RAM as a work area.

The tilt control unit 57, the writing unit 58, the blinking control unit 59, the amplifier control unit 61, and the count unit 62 may be implemented by one or more programmable logic devices such as FPGAs, or ASICs, for example. The inserting unit 51 and the extracting unit 52 may be implemented by one or more programmable logic devices such as FPGAs, or ASICs, for example. The disassembling unit 54 and the assembling unit 55 may be implemented by one or more programmable logic devices such as FPGAs, ASICs, of digital signal processors (DSPs), for example. The circuit information of the FPGAs may be stored in a non-volatile memory such as a rewritable ROM and a mask ROM.

FIG. 10 is a diagram of an example of a test packet in which information of levels of wavelengths is written. If the optical transmission apparatus A31 is the reception side optical transmission device, as depicted in FIG. 10, for example, for each of the wavelengths λ₁ to λ₄ of the optical signals transmitted from the transmission side optical transmission apparatus, data of levels is written into a payload 103 of an Ethernet packet 102 in a test packet 101. In FIG. 10, an upper row of a field for each wavelength indicates a wavelength and a level, and a lower row indicates an actually stored image by using ASCII (American Standard Code for Information Interchange) codes. For example, in the example depicted in FIG. 10, the levels of the wavelengths λ₁, λ₂, λ₃, and λ₄ are −14.5 dBm, −16.0 dBm, −15.5 dBm, and −13.5 dBm, respectively.

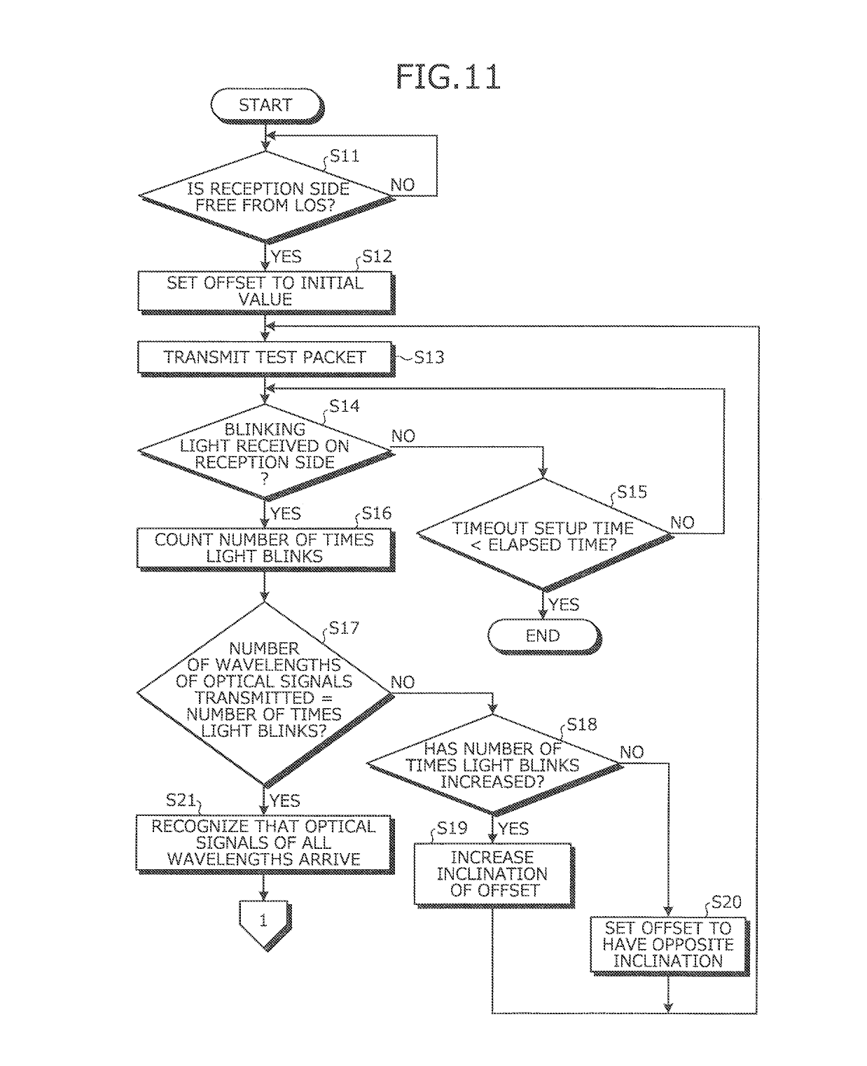

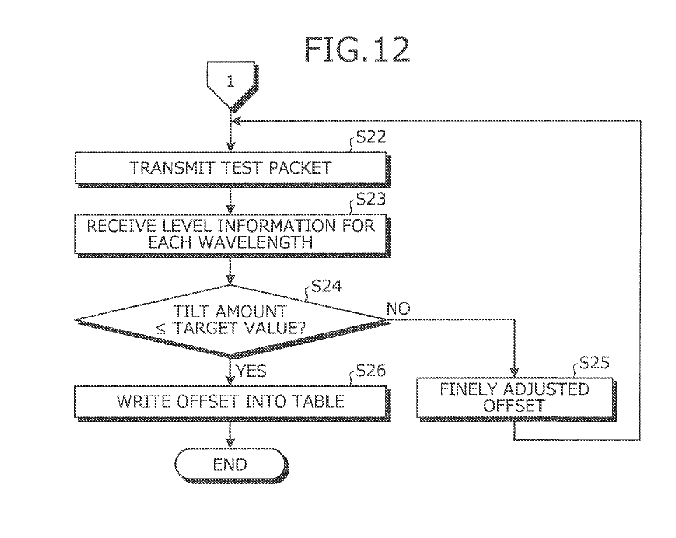

FIG. 11 is a diagram of a first example of a procedure, at the optical transmission apparatus according to the embodiment, for adjusting the offset related to tilt and FIG. 12 is a diagram continued from FIG. 11. As depicted in FIG. 11, when a process of adjusting the offset related to the tilt is started at the transmission side optical transmission apparatus, the transmission side optical transmission apparatus determines whether the reception side of the apparatus is free from the LOS (step S11).

If an optical signal of one or more wavelengths can be detected on the reception side of the apparatus, the transmission side optical transmission apparatus can determine that the reception side is free from the LOS. If an optical signal cannot be detected for any wavelength on the reception side of the apparatus, the transmission side optical transmission apparatus can determine that the reception side is not free from the LOS. Alternatively, since the monitoring terminal 37 monitors the LOS and LOL, the transmission side optical transmission apparatus may obtain information on whether the reception side has the LOS.

If the reception side of the transmission side optical transmission apparatus is not free from LOS (step S11: NO), the transmission side optical transmission apparatus waits for recovery from the LOS. Alternatively, the transmission side optical transmission apparatus may generate an error and terminate the process. If the reception side of the transmission side optical transmission apparatus is free from the LOS (step S11: YES), the transmission side optical transmission apparatus outputs a test packet from the inserting unit 51 to the checking unit 53. The checking unit 53 checks the destination of the test packet output from the inserting unit 51, supplies the table 56 with the information of the destination of the test packet, and outputs the test packet to the disassembling unit 54.

The table 56 supplies the amplifier control unit 61 with the information of the offset corresponding to the destination supplied from the checking unit 53. The offset has not been written into the table 56 immediately after the start of the process of adjusting the offset related to the tilt. Therefore, the table 56 supplies the amplifier control unit 61 with a preset initial value and as a result, the offset is set to the initial value in the amplifier control unit 61 (step S12). The initial value may be zero.

The disassembling unit 54 disassembles the test packet output from the checking unit 53, into parallel data and outputs the respective data to the E/O converters 79 to 82 of the corresponding wavelengths. The E/O converters 79 to 82 convert the date output from the disassembling unit 54 into optical signals. The optical signals output from the E/O converters 79 to 82 are amplified by the amplifiers 68 to 71, which are controlled by the amplifier control unit 61, given a transmission destination and a transmission path set by the optical switch 76, multiplexed by the multiplexing unit 87, amplified by the postamplifier 89, and output to the WDM ring network 38. In other words, the transmission side optical transmission apparatus transmits the test packet to the WDM ring network 38 (step S13).

Subsequently, the transmission side optical transmission apparatus determines whether the blinking light from the WDM ring network 38 has been received on the reception side of the transmission side optical transmission apparatus (step S14). If the blinking light has been received (step S14: YES), the procedure goes to step S16. If the blinking light has not been received (step S14: NO), the transmission side optical transmission apparatus enters a waiting state. If the elapsed time of the waiting state exceeds a predefined timeout setup time (step S15: YES), the transmission side optical transmission apparatus may generate an error and terminate the process.

Before the elapsed time of the waiting state reaches the timeout setup time (step S15: NO), if the blinking light is received on the reception side of the transmission side optical transmission apparatus (step S14: YES), the blinking light is amplified by the preamplifier 90 and demultiplexed by the demultiplexing unit 88 into the optical signals of respective wavelengths. The optical signals demultiplexed for respective wavelengths are sent by the optical switch 76, to the PDs 72 to 75 of the corresponding wavelength.

The transmission side optical transmission apparatus causes the PDs 72 to 75 to measure the levels of the blinking light at respective wavelengths, causes the ADC 63 to sum the levels of the blinking light, and causes the count unit 62 to count the number of times the light blinks (step S16). The transmission side optical transmission apparatus then causes the judging unit 60 to judge whether the number of times the light blinks is identical to the number of wavelengths of the optical signals transmitted by the transmission side optical transmission apparatus (step S17). If the number of times the light blinks is identical to the number of the transmission wavelengths of the transmission side optical transmission apparatus (step S17: YES), the procedure goes to step S21.

If the number of times the light blinks is not identical to the number of the transmission wavelengths of the transmission side optical transmission apparatus (step S17: NO), the transmission side optical transmission apparatus causes the judging unit 60 to judge whether the number of times the light blinks has increased as compared to the previous time (step S18). No previous data of the number of times the light blinks exists immediately after the start of the process of adjusting the offset related to the tilt since the comparison is made for the first time between the number of times the light blinks and the number of the transmission wavelengths. Therefore, the judging unit 60 instructs the tilt control unit 57 to set the offset to a predefined temporary value toward a shorter or longer wavelength, for example.

The tilt control unit 57 notifies the amplifier control unit 61 of the offset of the temporary value and, as a result, the offset is set to the temporary value in the amplifier control unit 61. The transmission side optical transmission apparatus transmits to the WDM ring network 38, the test packet with the temporary offset applied (step S13). The transmission side optical transmission apparatus executes the operations at steps S14 to S17 for the transmission of this packet. If the number of times the light blinks is identical to the number of the transmission wavelengths of the transmission side optical transmission apparatus (step S17: YES), the procedure goes to step S21.

If the number of times the light blinks is not identical to the number of the transmission wavelengths of the transmission side optical transmission apparatus in the second or subsequent comparison (step S17: NO), the transmission side optical transmission apparatus causes the judging unit 60 to judge whether the number of times the light blinks has increased as compared to the previous time (step S18). If the direction of the offset is correct, the number of wavelengths of optical signals receivable by the reception side optical transmission apparatus increases and therefore, the number of times the light received by the transmission side optical transmission apparatus blinks, is increased. Thus, if the number of times the light blinks is increased (step S18: YES), the judging unit 60 instructs the tilt control unit 57 to make the inclination of the offset larger.

The tilt control unit 57 notifies the amplifier control unit 61 of the offset changed to have the larger inclination, as a result, the offset changed to have the larger inclination is set in the amplifier control unit 61 (step S19). The transmission side optical transmission apparatus transmits to the WDM ring network 38, the test packet with the offset having the larger inclination applied (step S13).

On the other hand, if the direction of the offset is not correct, the number of wavelengths of optical signals receivable by the reception side optical transmission apparatus decreases and therefore, the number of times the light received by the transmission side optical transmission apparatus blinks, is decreased. Thus, if the number of times the light blinks is decreased (step S18: NO), the judging unit 60 instructs the tilt control unit 57 to invert the inclination of the offset.

The tilt control unit 57 notifies the amplifier control unit 61 of the offset changed to have the opposite inclination, as a result, the offset changed to have the opposite inclination is set in the amplifier control unit 61 (step S20). The transmission side optical transmission apparatus transmits to the WDM ring network 38, the test packet with the offset having the opposite inclination applied (step S13).

The transmission side optical transmission apparatus repeats the operations at steps S14 to S20 for the transmission of the test packet with the offset set at step S19 or S20 applied until the number of times the light blinks becomes identical to the number of the transmission wavelengths of the transmission side optical transmission apparatus at step S17. If the number of times the light blinks becomes identical to the number of the transmission wavelengths of the transmission side optical transmission apparatus at step S17, the transmission side optical transmission apparatus uses the judging unit 60 to recognize that the optical signals of all the wavelengths transmitted from the transmission side optical transmission apparatus, arrive at the reception side optical transmission apparatus and to judge that the offset is roughly correct (step S21).

The transmission side optical transmission apparatus retains, as a provisional value in memory, the offset when the number of times the light blinks becomes identical to the number of the transmission wavelengths of the transmission side optical transmission apparatus. The transmission side optical transmission apparatus may cause the writing unit 58 to write, as a provisional value into the table 56, the offset when the number of times the light blinks becomes identical to the number of the transmission wavelengths of the transmission side optical transmission apparatus. In the description of this example, the offset is written into the table 56. As a result of comparing the number of times the light blinks with the number of the transmission wavelengths of the transmission side optical transmission apparatus for the first time after the start of the process of adjusting the offset related to the tilt, if the number of times the light blinks is identical to the number of the transmission wavelengths of the transmission side optical transmission apparatus, the initial value of the offset is used as the provisional value.

Since the reception side optical transmission apparatus can receive the optical signals of all the wavelengths transmitted from the transmission side optical transmission apparatus at this point, the packet communication is enabled from the transmission side optical transmission apparatus to the reception side optical transmission apparatus. To enable the packet communication from the reception side optical transmission apparatus to the transmission side optical transmission apparatus, the optical transmission apparatus used as the transmission side optical transmission apparatus is defined as the reception side optical transmission apparatus, while the optical transmission apparatus used as the reception side optical transmission apparatus is defined as the transmission side optical transmission apparatus, and the operations at steps S11 to S21 described above are executed by the optical transmission apparatus defined as the transmission side optical transmission apparatus. If the packet communication becomes possible without a lack of wavelength in the both directions, the procedure goes to the process depicted in FIG. 12.

If the packet communication becomes possible in the both directions between the transmission side optical transmission apparatus and the reception side optical transmission apparatus, as depicted in FIG. 12, the transmission side optical transmission apparatus outputs a test packet from the inserting unit 51 to the checking unit 53. The checking unit 53 checks the destination of the test packet output from the inserting unit 51, supplies the table 56 with the information of the destination of the test packet, and outputs the test packet to the disassembling unit 54. The table 56 supplies the amplifier control unit 61 with the provisional value of the offset corresponding to the destination supplied from the checking unit 53.

The disassembling unit 54 disassembles the test packet output from the checking unit 53, into parallel data. The disassembled respective data are converted into optical signals by the E/O converters 79 to 82, are amplified by the amplifiers 68 to 71, which are controlled by the amplifier control unit 61 such that the provisional value of the offset is applied, and are output through the optical switch 76, the multiplexing unit 87, and the postamplifier 89 to the WDM ring network 38. In other words, the transmission side optical transmission apparatus transmits the test packet to the WDM ring network 38 (step S22).

In response to the test packet transmitted at step S22, the reception side optical transmission apparatus returns a test packet in which level information is written for each wavelength of optical signals received by the reception side optical transmission apparatus. The transmission side optical transmission apparatus disassembles the test packet in which the level information is written for each wavelength, into parallel data, and transmits the respective data assigned to optical signals having different wavelengths. The transmission side optical transmission apparatus receives the optical signals of the test packet in which the level information is written for each wavelength (step S23).

The optical signals of the test packet having the level information of each wavelength are amplified by the preamplifier 90 and demultiplexed by the demultiplexing unit 88 into optical signals of respective wavelengths. The optical signals demultiplexed for respective wavelengths are sent by the optical switch 76, to the O/E converters 83 to 86 of the corresponding wavelength and converted into electronic signals by the O/E converters 83 to 86. The converted electronic signals are assembled by the assembling unit 55 into the original test packet in which level information is written for each wavelength.

The transmission side optical transmission apparatus causes the extracting unit 52 to extract the level information of each wavelength, from the test packet in which level information is written for each wavelength and causes the judging unit 60 to judge if variation of levels between wavelengths, i.e., a tilt amount, is less than or equal to a target value based on the levels of the wavelengths (step S24). If the tilt amount is less than or equal to the target value (step S24: YES), the procedure goes to step S26.

If the tilt amount is not less than or equal to the target value (step S24: NO), the judging unit 60 instructs the tilt control unit 57 to finely adjust the offset. The tilt control unit 57 supplies the finely adjusted offset to the amplifier control unit 61 and, as a result, the finely adjusted offset is set in the amplifier control unit 61 (step S25). The transmission side optical transmission apparatus transmits to the WDM ring network 38, the test packet with the finely adjusted offset applied (step S22).

The transmission side optical transmission apparatus repeats the operations at steps S22 to S25 until the tilt amount becomes less than or equal to the target value at step S24. If the tilt amount becomes less than or equal to the target value (step S24: YES), the judging unit 60 instructs the writing unit 58 to write an offset value. In accordance with the write instruction from the judging unit 60, the writing unit 58 writes into the table 56, the offset for when the tilt amount becomes less than or equal to the target value (step S26). When the offset is written into the table 56 as described above, a series of operations at the transmission side optical transmission apparatus is terminated.

The offset at the transmission side optical transmission apparatus is optimized at this point in the packet communication from the transmission side optical transmission apparatus to the reception side optical transmission apparatus. As a result, the tilt amount of the optical signals received by the reception side optical transmission apparatus is corrected. The offset at the reception side optical transmission apparatus must then be optimized in the packet communication from the reception side optical transmission apparatus to the transmission side optical transmission apparatus so as to correct the tilt amount of the optical signals received by the transmission side optical transmission apparatus.

Therefore, the optical transmission apparatus used as the transmission side optical transmission apparatus is defined as the reception side optical transmission apparatus, while the optical transmission apparatus used as the reception side optical transmission apparatus is defined as the transmission side optical transmission apparatus, and the operations at steps S22 to S26 described above is executed in the optical transmission apparatus defined as the transmission side optical transmission apparatus. As a result, since the offset is optimized in the both direction, the tilt amount can be corrected between the optical transmission apparatuses opposite to each other.

Description will be made of an example of operation of the reception side optical transmission apparatus when the transmission side optical transmission apparatus executes the operations at steps S11 to S21 described above. The configuration of the reception side optical transmission apparatus is the same as the configuration of the transmission side optical transmission apparatus and is the same configuration as the optical transmission apparatus A31 depicted in FIG. 9, for example. Therefore, the reference numerals added to the names of units in FIG. 9 are used in the description of operation of the reception side optical transmission apparatus.

When the transmission side optical transmission apparatus transmits to the WDM ring network 38, an optical signal assigned with data formed by disassembling the test packet at step S13 of FIG. 11, the reception side optical transmission apparatus receives the optical signal from the WDM ring network 38. The reception side optical transmission apparatus causes the preamplifier 90 to amplify the received optical signal and the demultiplexing unit 88 to perform demultiplexing into optical signals of respective wavelengths. The optical signals demultiplexed according to wavelength are sent to the PDs 72 to 75 of the corresponding wavelength by the optical switch 76.

The reception side optical transmission apparatus causes the PDs 72 to 75 to measure the levels of the optical signals, for each wavelength. The reception side optical transmission apparatus causes the ADC 63 to sum the levels of the optical signals, and causes the count unit 62 to count the number of wavelengths at levels receivable by the O/E converters 83 to 86. The reception side optical transmission apparatus causes the judging unit 60 to write the number of times the light blinks into the blinking control unit 59, based on the count information of the number of wavelengths counted by the count unit 62.

At the reception side optical transmission apparatus, the blinking control unit 59 causes the E/O converters 79 to 82 to blink the number of times written by the judging unit 60. Since the offset has not been written into the table 56 of the reception side optical transmission apparatus at this point, the offset is not applied to the amplifiers 68 to 71 by the amplifier control unit 61. Therefore, the E/O converters 79 to 82 blink at the same level.

The blinking lights are amplified by the amplifiers 68 to 71, given a transmission destination and a transmission path set by the optical switch 76, multiplexed by the multiplexing unit 87, amplified by the postamplifier 89, and output to the WDM ring network 38. The blinking light output from the reception side optical transmission apparatus to the WDM ring network 38 is received by the transmission side optical transmission apparatus at step S14 of FIG. 11.

When the transmission side optical transmission apparatus transmits to the WDM ring network 38 the optical signal assigned with data formed by disassembling the test packet at step S22 of FIG. 12, the reception side optical transmission apparatus receives the optical signal from the WDM ring network 38. The reception side optical transmission apparatus causes the preamplifier 90 to amplify the received optical signal and the demultiplexing unit 88 to perform demultiplexing into the optical signals of the respective wavelengths. The optical signals demultiplexed according to wavelength are sent to the PDs 72 to 75 and the O/E converters 83 to 86 of the corresponding wavelength by the optical switch 76.

The reception side optical transmission apparatus causes the PDs 72 to 75 to measure the levels of the optical signals, for each wavelength and causes the ADC 63 to sum the levels of the optical signals. The reception side optical transmission apparatus causes the count unit 62 to count the information of the summed levels and notifies the judging unit 60 of the levels of the respective wavelengths. At the reception side optical transmission apparatus, the judging unit 60 causes the blinking control unit 59 to stop the blinking of the E/O converters 79 to 82. As a result, the E/O converters 79 to 82 stop blinking. The judging unit 60 notifies the inserting unit 51 of the levels of the respective wavelengths notified from the count unit 62.

At the reception side optical transmission apparatus, the inserting unit 51 writes the information of levels of wavelengths into a test packet and outputs the test packet to the checking unit 53. The checking unit 53 checks the destination of the test packet output from the inserting unit 51, supplies the table 56 with the information of the destination of the test packet, and outputs the test packet to the disassembling unit 54. The table 56 supplies the amplifier control unit 61 with the provisional value of the offset corresponding to the destination supplied from the checking unit 53.

The disassembling unit 54 disassembles the test packet output from the checking unit 53 into parallel data. The disassembled respective data are converted into optical signals by the E/O converters 79 to 82, amplified by the amplifiers 68 to 71, which are controlled by the amplifier control unit 61 such that the provisional value of the offset is applied, and are output through the optical switch 76, the multiplexing unit 87, and the postamplifier 89 to the WDM ring network 38. The test packet having the information of levels of wavelengths output from the reception side optical transmission apparatus to the WDM ring network 38 is received by the transmission side optical transmission apparatus at step S23 of FIG. 12.

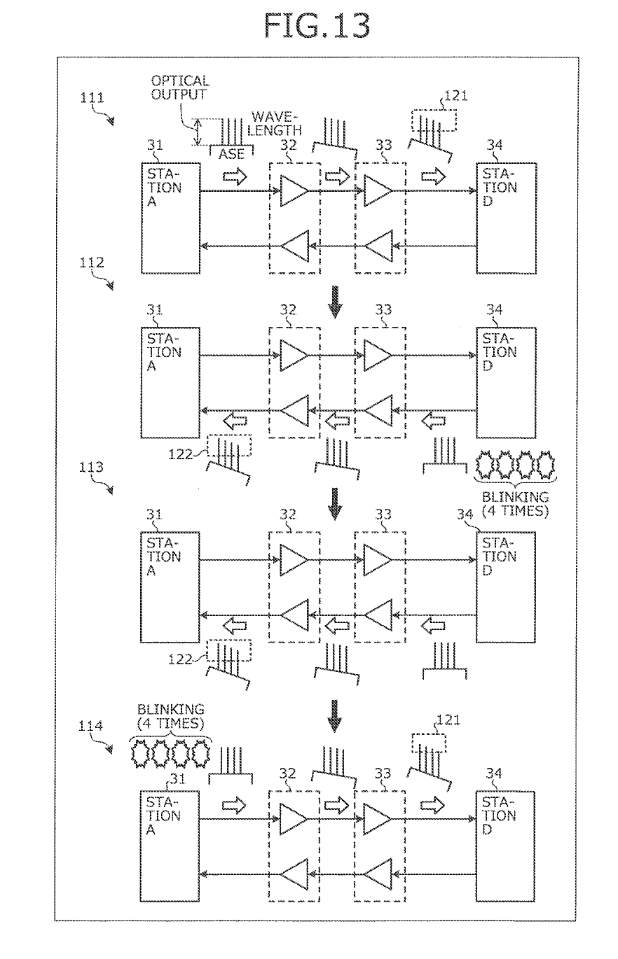

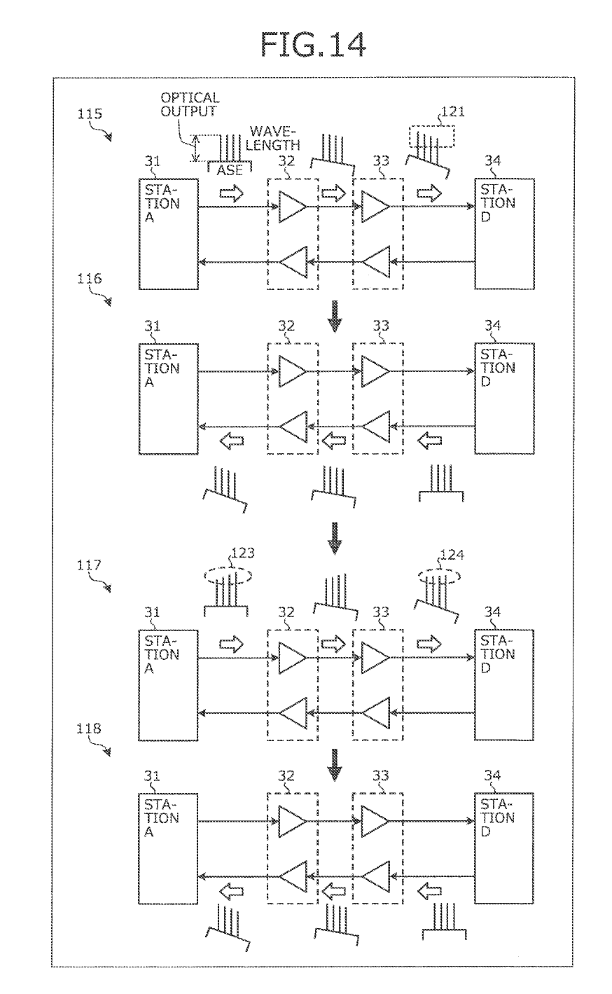

FIG. 13 is a diagram of a first specific example of a procedure of adjusting the offset related to the tilt and FIG. 14 is a diagram continued from FIG. 13. The example depicted in FIGS. 13 and 14 is an example when the number of times the light blinks is identical to the number of transmission wavelengths of the transmission side optical transmission apparatus as a result of comparing the number of times the light blinks with the number of transmission wavelengths of the transmission side optical transmission apparatus for the first time after the start of the process of adjusting the offset related to the tilt, in the first example of the procedure of adjusting the offset related to the tilt described above. In the description of this example, the offset related to the tilt is adjusted between the optical transmission apparatus A31 and the optical transmission apparatus D34.

In FIGS. 13 and 14, the optical transmission apparatus A31 is denoted by STATION A and the optical transmission apparatus D34 is denoted by STATION D. The optical transmission apparatus B32 and the optical transmission apparatus C33 act as optical relay apparatuses. An optical signal output from the optical transmission apparatus A31 is relayed by the optical transmission apparatus B32 and the optical transmission apparatus C33 and arrives at the optical transmission apparatus D34, and an optical signal output from the optical transmission apparatus D34 arrives at the optical transmission apparatus A31 through the reverse route. The number of wavelengths of the optical signals transmitted by the optical transmission apparatus A31 and the optical transmission apparatus D34 is four.

In FIG. 13, as indicated by reference numeral 111, the optical transmission apparatus A31 transmits the optical signals of the test packet with the offset set to the initial value. The transmitted optical signals are subject to a tilt 121 between wavelengths consequent to the characteristics of linear amplifiers and transmission lines in the relay points of the optical transmission apparatus B32 and the optical transmission apparatus C33. However, in this example, the optical signals of all the wavelengths are within the dynamic range of the optical transmission apparatus D34 and therefore, the optical transmission apparatus D34 receives the optical signals of all the wavelengths.

In FIG. 13, as indicated by reference numeral 112, the optical transmission apparatus D34 blinks the optical signals of all the wavelengths the number of times same as the number of wavelengths of the received optical signals, i.e., four times in this example, at the same level. The transmitted optical signals are subject to a tilt 122 between wavelengths consequent to the characteristics of the linear amplifiers and the transmission lines in the relay points of the optical transmission apparatus C33 and the optical transmission apparatus B32. However, since the state of LOL or LOS does not exist between the optical transmission apparatus A31 and the optical transmission apparatus D34, the level of an optical signal of at least one wavelength falls within the dynamic range of the optical transmission apparatus A31. Therefore, the optical transmission apparatus A31 can recognize the number of times the light blinks of the received optical signal. In the example depicted in FIG. 13, it is assumed that the optical signals of all the wavelengths fall within the dynamic range of the optical transmission apparatus A31. Since the number of times the light blinks of the received optical signals is identical to the number of wavelengths of the optical signals transmitted by the transmission side optical transmission apparatus, the optical transmission apparatus A31 stops the transmission of the test packet.

In FIG. 13, as indicated by reference numeral 113, the optical transmission apparatus D34 transmits the optical signals of the test packet with the offset set to the initial value. The transmitted optical signals are subject to the tilt 122 between wavelengths consequent to the characteristics of the linear amplifiers and the transmission lines in the relay points of the optical transmission apparatus C33 and the optical transmission apparatus B32. However, in this example, the optical signals of all the wavelengths are within the dynamic range of the optical transmission apparatus A31 and therefore, the optical transmission apparatus A31 receives the optical signals of all the wavelengths.

In FIG. 13, as indicated by reference numeral 114, the optical transmission apparatus A31 blinks the optical signals of all the wavelengths, a number of times equivalent to the number of wavelengths of the received optical signals, i.e., four times in this example, at the same level. The transmitted optical signals are subject to the tilt 121 between wavelengths consequent to the characteristics of the linear amplifiers and the transmission lines in the relay points of the optical transmission apparatus B32 and the optical transmission apparatus C33. However, since the state of LOL or LOS does not exist between the optical transmission apparatus A31 and the optical transmission apparatus D34, the level of an optical signal of at least one wavelength falls within the dynamic range of the optical transmission apparatus D34. Therefore, the optical transmission apparatus D34 can recognize the number of times the light blinks of the received optical signal. In the example depicted in FIG. 13, it is assumed that the optical signals of all the wavelengths fall within the dynamic range of the optical transmission apparatus D34. Since the number of times the light blinks of the received optical signals is identical to the number of wavelengths of the optical signals transmitted by the transmission side optical transmission apparatus, the optical transmission apparatus D34 stops the transmission of the test packet.

At this point, although the tilts 121 and 122 between wavelengths occur in both the optical transmission apparatus A31 and the optical transmission apparatus D34, the levels of the optical signals of all the wavelengths are within the dynamic ranges of the optical transmission apparatus A31 and the optical transmission apparatus D34. Therefore, the optical transmission apparatus A31 and the optical transmission apparatus D34 can recognize the packet signals with the offset kept at the initial value.

In FIG. 14, as indicated by reference numeral 115, the optical transmission apparatus A31 transmits the optical signals of the test packet with the offset set to the initial value. Since the optical signals of all the wavelengths transmitted from the optical transmission apparatus A31 are within the dynamic range of the optical transmission apparatus D34, the optical transmission apparatus D34 receives the optical signals of all the wavelengths. The optical transmission apparatus D34 measures the levels of the received optical signals, for each wavelength.

In FIG. 14, as indicated by reference numeral 116, the optical transmission apparatus D34 writes the levels of the optical signals of the wavelengths into a test packet and transmits the test packet as the optical signals of the wavelengths to the optical transmission apparatus A31. The optical transmission apparatus A31 receives and assembles the optical signals of the wavelengths into the original test packet and extracts the levels of the optical signals of the wavelengths from the test packet to calculate an attenuation amount in the optical transmission apparatus D34.

In FIG. 14, as indicated by reference numeral 117, the optical transmission apparatus A31 calculates the offset based on the attenuation amount of the optical signals of the wavelengths. The optical transmission apparatus A31 sets a test packet as the optical signals of the wavelengths and transmits to the optical transmission apparatus D34, the optical signals of the wavelengths with a calculated offset 123 applied. The offset applied to the optical signals of the wavelengths is canceled by the tilt consequent to the linear amplifiers and the transmission lines in the relay points of the optical transmission apparatus B32 and the optical transmission apparatus C33. As a result, variation 124 of the levels between wavelengths in the optical transmission apparatus D34 is reduced. The optical transmission apparatus D34 measures levels of the received optical signals for respective wavelengths.

In FIG. 14, as indicated by reference numeral 118, the optical transmission apparatus D34 writes the levels of the optical signals of the wavelengths into a test packet and transmits to the optical transmission apparatus A31, the test packet as the optical signals of the wavelengths. The optical transmission apparatus A31 receives and assembles the optical signals of the wavelengths, into the original test packet and extracts the levels of the optical signals of the wavelengths from the test packet to calculate a tilt amount in the optical transmission apparatus D34. If the calculated tilt amount is less than or equal to the target value, the optical transmission apparatus A31 terminates the process of adjusting the offset related to the tilt. If the calculated tilt amount exceeds the target value, the optical transmission apparatus A31 calculates the offset based on the attenuation amount of the optical signals of the wavelengths and transmits to the optical transmission apparatus D34, the optical signals of the wavelengths with the calculated offset applied so as to readjust the offset.

At this point, setting is completed for an offset value cancelling the tilt occurring in the optical signals transmitted from the optical transmission apparatus A31 to the optical transmission apparatus D34. Subsequently, an offset value is also set for the optical signals transmitted from the optical transmission apparatus D34 to the optical transmission apparatus A31 in the same procedure as that depicted in FIG. 14.

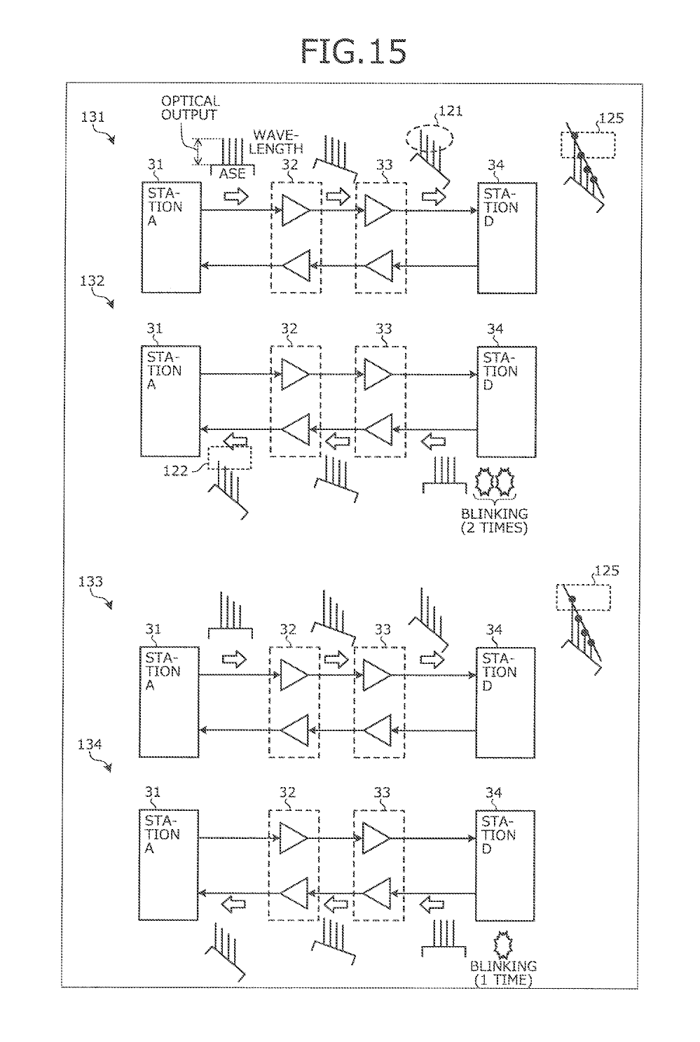

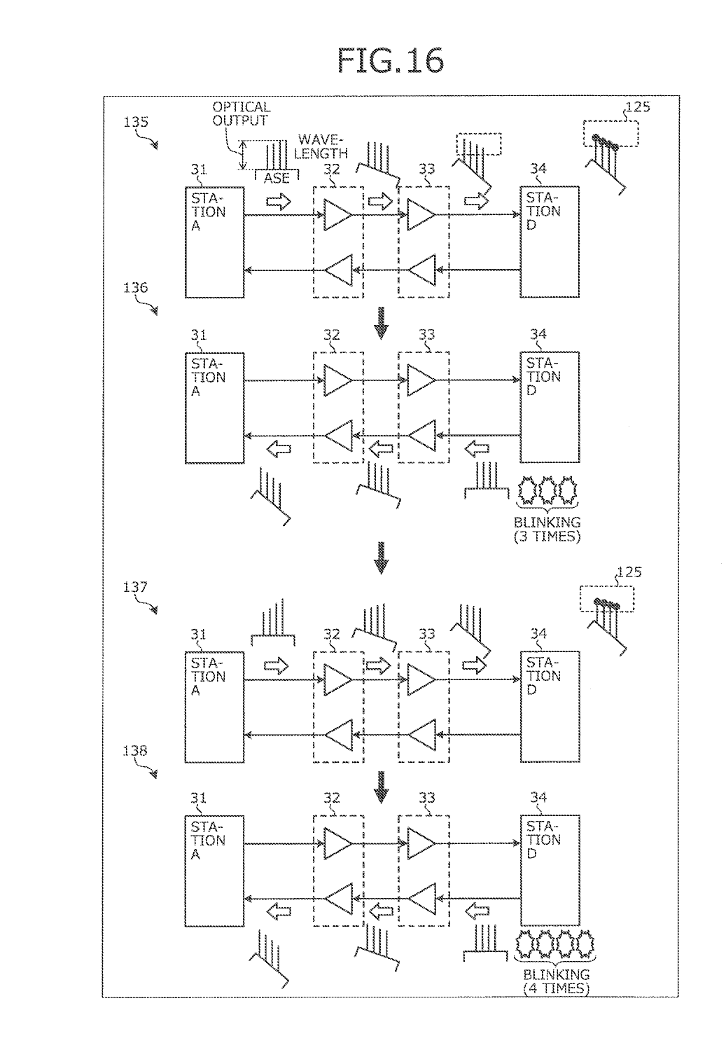

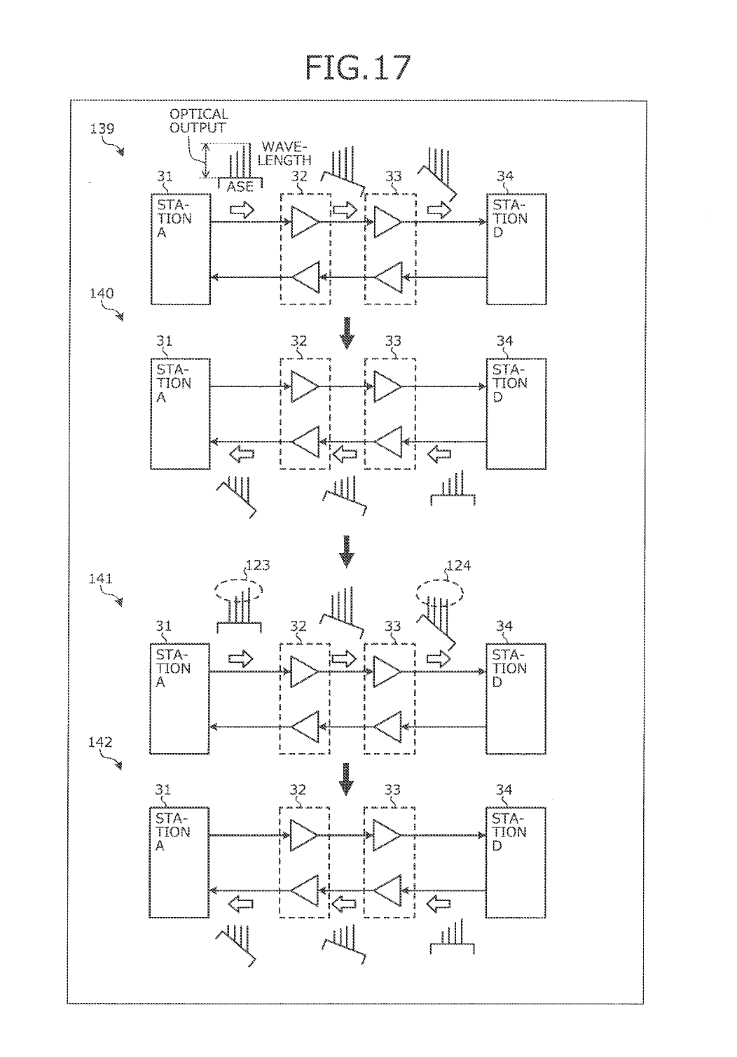

FIG. 15 is a diagram of a second specific example of the procedure of adjusting the offset related to the tilt and FIG. 16 is a diagram continued from FIG. 15. FIG. 17 is a diagram continued from FIG. 16. The example depicted in FIGS. 15 to 17 is depict an example when the number of times the light blinks is not identical to the number of transmission wavelengths of the transmission side optical transmission apparatus as a result of comparing the number of times the light blinks with the number of transmission wavelengths of the transmission side optical transmission apparatus for the first time after the start of the process of adjusting the offset related to the tilt, in the first example of the procedure of adjusting the offset related to the tilt described above. In the description of this example, the offset related to the tilt is adjusted between the optical transmission apparatus A31 and the optical transmission apparatus D34.

In FIGS. 15 to 17, the optical transmission apparatus A31 is denoted by STATION A and the optical transmission apparatus D34 is denoted by STATION D. The optical transmission apparatus B32 and the optical transmission apparatus C33 act as optical relay apparatuses. An optical signal output from the optical transmission apparatus A31 is relayed by the optical transmission apparatus B32 and the optical transmission apparatus C33 and arrives at the optical transmission apparatus D34, and an optical signal output from the optical transmission apparatus D34 arrives at the optical transmission apparatus A31 through the reverse route. The number of wavelengths of the optical signals transmitted by the optical transmission apparatus A31 and the optical transmission apparatus D34 is four.

In FIG. 15, as indicated by reference numeral 131, the optical transmission apparatus A31 transmits the optical signals of the test packet with the offset set to the initial value. The transmitted optical signals are subject to the tilt 121 between wavelengths consequent to the characteristics of the linear amplifiers and the transmission lines in the relay points of the optical transmission apparatus B32 and the optical transmission apparatus C33. As a result, among the optical signals transmitted from the optical transmission device A31, although optical signals of some wavelengths are within the dynamic range of the optical transmission apparatus D34, optical signals of the remaining wavelengths are not within the dynamic range of the optical transmission apparatus D34. In this example, among the optical signals of the four wavelengths transmitted from the optical transmission apparatus A31, optical signals of two wavelengths fall within a dynamic range 125 of the optical transmission apparatus D34. Therefore, the optical transmission apparatus D34 recognizes the reception of the optical signals of the two wavelengths.

In FIG. 15, as indicated by reference numeral 132, the optical transmission apparatus D34 blinks the optical signals of all the wavelengths the number of times same as the number of wavelengths of the received optical signals, i.e., two times in this example, at the same level. The transmitted optical signals are subject to the tilt 122 between wavelengths consequent to the characteristics of the linear amplifiers and the transmission lines in the relay points of the optical transmission apparatus C33 and the optical transmission apparatus B32. However, since the state of LOL or LOS does not exist between the optical transmission apparatus A31 and the optical transmission apparatus D34, the level of an optical signal of at least one wavelength falls within the dynamic range of the optical transmission apparatus A31. Therefore, the optical transmission apparatus A31 recognizes the number of times the light blinks of a received optical signal and judges that the number of times the light blinks of the received optical signal is not identical to the number of the wavelengths of the optical signals transmitted by the optical transmission apparatus A31.

In FIG. 15, as indicated by reference numeral 133, the optical transmission apparatus A31 transmits the optical signals of the test packet with the offset provisionally set toward a shorter wavelength, for example. As a result, the number of wavelengths falling within the dynamic range 125 of the optical transmission apparatus D34 is reduced and, for example, it is assumed that an optical signal of one wavelength falls within the dynamic range 125 of the optical transmission apparatus D34. In this case, the optical transmission apparatus D34 recognizes the reception of the optical signal of the one wavelength.

In FIG. 15, as indicated by reference numeral 134, the optical transmission apparatus D34 blinks the optical signals of all the wavelengths a number of times equivalent to the number of wavelengths of the received optical signals, i.e., one time in this example, at the same level. As a result, the optical transmission apparatus A31 recognizes the number of times the light blinks of a received optical signal and recognizes that the number of times the light blinks of the received optical signal is not identical to the number of the wavelengths of the optical signals transmitted by the optical transmission apparatus A31 and that the number of the wavelengths is reduced as compared to the previous time. Since the number of the wavelengths is reduced as compared to the previous time, the optical transmission apparatus A31 judges that the direction of the provisionally set offset is wrong.

In FIG. 16, as indicated by reference numeral 135, the optical transmission apparatus A31 transmits the optical signals of the test packet with the offset set in the direction opposite to the previous provisionally set offset, i.e., toward a longer wavelength, for example. As a result, the number of wavelengths falling within the dynamic range 125 of the optical transmission apparatus D34 is increased and, for example, it is assumed that optical signals of three wavelengths fall within the dynamic range 125 of the optical transmission apparatus D34. In this case, the optical transmission apparatus D34 recognizes the reception of the optical signals of the three wavelengths.

In FIG. 16, as indicated by reference numeral 136, the optical transmission apparatus D34 blinks the optical signals of all the wavelengths a number of times equivalent to the number of wavelengths of the received optical signals, i.e., three times in this example, at the same level. As a result, the optical transmission apparatus A31 recognizes the number of times the light blinks of a received optical signal and recognizes that the number of times the light blinks of the received optical signal is not identical to the number of the wavelengths of the optical signals transmitted by the optical transmission apparatus A31 and that the number of the wavelengths is increased as compared to the previous time. Since the number of the wavelengths is increased as compared to the previous time, the optical transmission apparatus A31 judges that the direction of the currently set offset is correct.

In FIG. 16, as indicated by reference numeral 137, the optical transmission apparatus A31 transmits the optical signals of the test packet with the offset set larger than the previous time in the correct direction, i.e., toward a longer wavelength, for example. As a result, the number of wavelengths falling within the dynamic range 125 of the optical transmission apparatus D34 is increased and, for example, it is assumed that optical signals of four wavelengths fall within the dynamic range 125 of the optical transmission apparatus D34. In this case, the optical transmission apparatus D34 recognizes the reception of the optical signals of the four wavelengths.

In FIG. 16, as indicated by reference numeral 138, the optical transmission apparatus D34 blinks the optical signals of all the wavelengths a number of times equivalent to the number of wavelengths of the received optical signals, i.e., four times in this example, at the same level. As a result, the optical transmission apparatus A31 recognizes the number of times the light blinks of a received optical signal and recognizes that the number of times the light blinks of the received optical signal is identical to the number of the wavelengths of the optical signals transmitted by the optical transmission apparatus A31. The optical transmission apparatus A31 then stops the transmission of the test packet.

At this point, with regard to the transmission of the optical signals from the optical transmission apparatus A31 to the optical transmission apparatus D34, the levels of the optical signals of all the wavelengths fall within the dynamic range of the optical transmission apparatus D34 although tilt between wavelengths occurs. Therefore, since a packet signal from the optical transmission apparatus A31 to the optical transmission apparatus D34 can be recognized, a provisional value of the offset is determined.

Subsequently, the offset in the optical transmission apparatus D34 is adjusted such that the levels of the optical signals of all the wavelengths transmitted from the optical transmission apparatus D34 fall within the dynamic range of the optical transmission apparatus A31 in the same way as the procedure depicted in FIGS. 15 and 16. As a result, since a packet signal can also be recognized with regard to the transmission of the optical signals from the optical transmission apparatus D34 to the optical transmission apparatus A31 although tilt between wavelengths occurs, a provisional value of the offset is determined.

In FIG. 17, as indicated by reference numeral 139, the optical transmission apparatus A31 transmits the optical signals of the test packet with the offset set to the provisional value. Since the optical signals of all the wavelengths transmitted from the optical transmission apparatus A31 are within the dynamic range of the optical transmission apparatus D34, the optical transmission apparatus D34 receives the optical signals of all the wavelengths. The optical transmission apparatus D34 measures the levels of the received optical signals, for each wavelength.

In FIG. 17, as indicated by reference numeral 140, the optical transmission apparatus D34 writes the levels of the optical signals of the wavelengths into a test packet and transmits the test packet as the optical signals of the wavelengths to the optical transmission apparatus A31. The optical transmission apparatus A31 receives and assembles the optical signals of the wavelengths, into the original test packet and extracts the levels of the optical signals of the wavelengths from the test packet to calculate an attenuation amount in the optical transmission apparatus D34.

In FIG. 17, as indicated by reference numeral 141, the optical transmission apparatus A31 calculates the offset based on the attenuation amount of the optical signals of the wavelengths. The optical transmission apparatus A31 sets a test packet as the optical signals of the wavelengths and transmits to the optical transmission apparatus D34 the optical signals of the wavelengths with the calculated offset 123 applied. The offset applied to the optical signals of the wavelengths is canceled by the tilt consequent to the linear amplifiers and the transmission lines in the relay points of the optical transmission apparatus B32 and the optical transmission apparatus C33. As a result, the variation 124 of the levels between wavelengths in the optical transmission apparatus D34 is reduced. The optical transmission apparatus D34 measures levels of the received optical signals for respective wavelengths.

In FIG. 17, as indicated by reference numeral 142, the optical transmission apparatus D34 writes the levels of the optical signals of the wavelengths into a test packet and transmits the test packet as the optical signals of the wavelengths to the optical transmission apparatus A31. The optical transmission apparatus A31 receives and assembles the optical signals of the wavelengths into the original test packet and extracts the levels of the optical signals of the wavelengths from the test packet to calculate a tilt amount in the optical transmission apparatus D34. If the calculated tilt amount is less than or equal to the target value, the optical transmission apparatus A31 terminates the process of adjusting the offset related to the tilt. If the calculated tilt amount exceeds the target value, the optical transmission apparatus A31 calculates the offset based on the attenuation amount of the optical signals of the wavelengths and transmits to the optical transmission apparatus D34 the optical signals of the wavelengths with the calculated offset applied so as to readjust the offset.

At this point, setting is completed for an offset value cancelling the tilt occurring in the optical signals transmitted from the optical transmission apparatus A31 to the optical transmission apparatus D34. Subsequently, an offset value is also set for the optical signals transmitted from the optical transmission apparatus D34 to the optical transmission apparatus A31 in the same procedure as that depicted in FIG. 17.

According to the optical transmission apparatus depicted in FIG. 9, and the optical transmission system having the optical transmission apparatus depicted in FIG. 9, or the optical transmission method depicted in FIGS. 11 to 17, the transmission side optical transmission apparatus is notified of the number of optical signals receivable by the reception side optical transmission apparatus through the number of times the light blinks of light transmitted from the reception side optical transmission apparatus. The transmission side optical transmission apparatus repeats the transmission of optical signals, the reception of the number of times the light blinks of light, and the adjustment of offset until the number of times the light blinks of light received becomes identical to the number of the wavelengths of the optical signals transmitted by the transmission side optical transmission apparatus, thereby obtaining the offset enabling the reception side optical transmission apparatus to receive the optical signals of all the wavelengths transmitted by the transmission side optical transmission apparatus. Therefore, the tilt correction can be performed at the transmission side optical transmission apparatus such that the reception side optical transmission apparatus can receive the optical signals of all the wavelengths transmitted by the transmission side optical transmission apparatus.

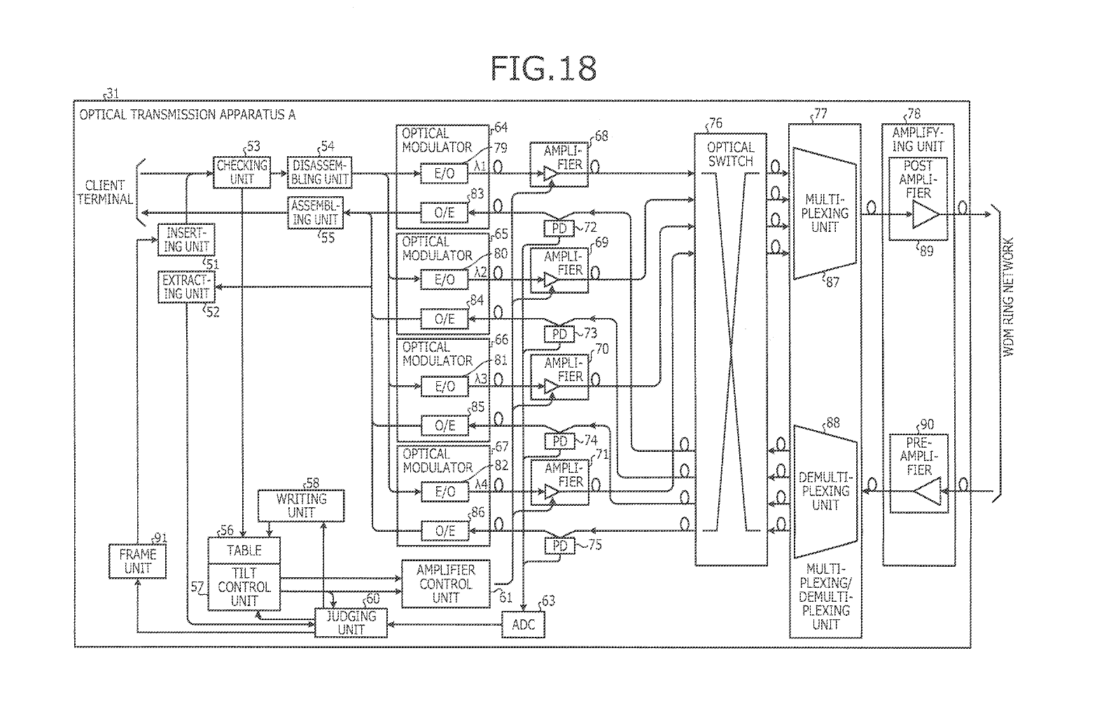

FIG. 18 is a diagram of a third example of the optical transmission apparatus according to the embodiment. In the third example of the optical transmission apparatus, the number of wavelengths of received optical signals is notified by using information of reception levels during adjustment of the offset related to the tilt.

The optical transmission apparatus depicted in FIG. 18 may be an example of the optical transmission apparatuses 31 to 36 in the optical transmission system depicted in FIG. 5. In the description of this example, the optical transmission apparatus depicted in FIG. 18 is the optical transmission apparatus A31 in the optical transmission system depicted in FIG. 5. The optical transmission apparatuses 32 to 36 are the same as the optical transmission apparatus A31 and therefore, will not be described. In the maintenance mode of adjusting the offset related to the tilt, each of the optical transmission apparatuses 31 to 36 may act as the transmission side optical transmission apparatus or may act as the reception side optical transmission apparatus.

As depicted in FIG. 18, the optical transmission apparatus A31 has the inserting unit 51, the extracting unit 52, the checking unit 53, the disassembling unit 54, the assembling unit 55, the table 56, the tilt control unit 57, the writing unit 58, the judging unit 60, the amplifier control unit 61, the ADC 63, and a frame unit 91. The optical transmission apparatus A31 has the optical modulators 64 to 67, the amplifiers 68 to 71, the PDs 72 to 75, the optical switch 76, the multiplexing/demultiplexing unit 77, and the amplifying unit 78. The optical modulators 64 to 67 respectively have the E/O converters 79 to 82 and the O/E converters 83 to 86. The multiplexing/demultiplexing unit 77 has the multiplexing unit 87 and the demultiplexing unit 88. The amplifying unit 78 has the postamplifier 89 and the preamplifier 90.

The checking unit 53, the disassembling unit 54, the table 56, the tilt control unit 57, the writing unit 58, the amplifier control unit 61, and the O/E converters 83 to 86 are the same as the respective constituent units in the second example of the optical transmission apparatus described above. Therefore, these units will not be described again.

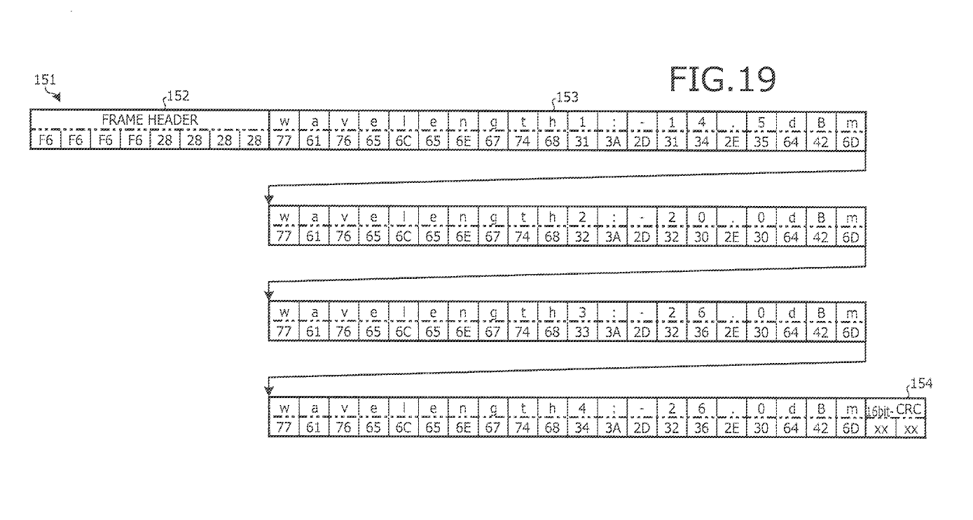

The frame unit 91 is connected to the judging unit 60. In the reception side apparatus case, the frame unit 91 frames information of levels of wavelengths sent from the judging unit 60. FIG. 19 depicts an example of a frame in which the information of levels of wavelengths is written.

The inserting unit 51 is connected to the frame unit 91. In the transmission side apparatus case, the inserting unit 51 sequentially outputs test packets to the checking unit 53. In the reception side apparatus case, the inserting unit 51 outputs to the checking unit 53, a test packet including framed data sent from the frame unit 91.

The E/O converters 79 to 82 are connected to the disassembling unit 54. The E/O converters 79 to 82 convert the data output from the disassembling unit 54, into optical signals.

The amplifiers 68 to 71 are connected to the E/O converters 79 to 82 and the amplifier control unit 61. The amplifiers 68 to 71 are controlled by the amplifier control unit 61 to amplify the optical signals output from the E/O converters 79 to 82.

The optical switch 76 is connected to the amplifiers 68 to 71 and the demultiplexing unit 88 of the multiplexing/demultiplexing unit 77. The optical switch 76 sets transmission destinations and transmission paths according to the destination of the packet to output to the multiplexing unit 87 of the multiplexing/demultiplexing unit 77, the optical signals output from the amplifiers 68 to 71. According to wavelength, the optical switch 76 outputs to the PDs 72 to 75 and the O/E converters 83 to 86 of the optical modulators 64 to 67, the optical signals or the blinking light output from the demultiplexing unit 88.

The multiplexing unit 87 is connected to the optical switch 76. The multiplexing unit 87 multiplexes and outputs to the postamplifier 89 of the amplifying unit 78, the optical signals having different wavelengths output from the optical switch 76.

The postamplifier 89 is connected to the multiplexing unit 87 and the WDM ring network 38 not depicted. The postamplifier 89 amplifies and outputs to the WDM ring network 38, the optical signal output from the multiplexing unit 87.

The preamplifier 90 is connected to the WDM ring network 38 (not depicted). The preamplifier 90 receives, amplifies, and outputs to the demultiplexing unit 88 of the multiplexing/demultiplexing unit 77, the optical signal input from the WDM ring network 38.

The demultiplexing unit 88 is connected to the preamplifier 90. The demultiplexing unit 88 demultiplexes the optical signal output from the preamplifier 90 into optical signals of respective wavelengths and outputs the optical signals to the optical switch 76.

The PDs 72 to 75 are connected to the optical switch 76. The PDs 72 to 75 measure according to wavelength, the levels of optical signals output from the optical switch 76, convert the levels into electronic signals that correspond to the levels of the optical signals, and output the electronic signals to the ADC 63.

The ADC 63 is connected to the PDs 72 to 75. The ADC 63 converts the analog signals output from the PDs 72 to 75 into digital signals, and outputs the digital signals to the count unit 62.

The assembling unit 55 is connected to the O/E converters 83 to 86 and a client terminal (not depicted). In the normal operation mode, the assembling unit 55 assembles the electronic signals output from the O/E converters 83 to 86 into a packet and outputs the packet to the client terminal.

The extracting unit 52 is connected to the O/E converters 83 to 86. The extracting unit 52 synchronizes a data frame included in a test packet output from the O/E converters 83 to 86, checks validity of data by a cyclic redundancy check (CRC), and transmits data including level information of wavelengths to the judging unit 60.

The judging unit 60 is connected to the tilt control unit 57, the extracting unit 52, and the ADC 63. In the transmission side apparatus case, the judging unit 60 compares the number of wavelengths receivable by the reception side optical transmission apparatus with the number of wavelengths of the optical signals transmitted by the apparatus of the judging unit 60, based on the data including the level information of wavelengths sent from the extracting unit 52. As a result of the comparison, if the number of wavelengths receivable by the reception side optical transmission apparatus is not identical to the number of the transmission wavelengths of the apparatus and if this is a first comparison after a transition to the maintenance mode of adjusting the offset related to the tilt, the judging unit 60 determines the inclination direction of the tilt based on the data including the level information of wavelengths sent from the extracting unit 52. The judging unit 60 outputs to the tilt control unit 57, an offset change instruction to apply the offset having inclination in the direction opposite to the inclination direction of the tilt.

If the number of wavelengths receivable by the reception side optical transmission apparatus is not identical to the number of the transmission wavelengths of the apparatus and if this is a second or later comparison after a transition to the maintenance mode of adjusting the offset related to the tilt, the judging unit 60 obtains information of the offset at this time point from the tilt control unit 57. Based on the data including the level information of wavelengths, the judging unit 60 outputs to the tilt control unit 57, an offset change instruction to change the offset such that the number of wavelengths receivable by the reception side optical transmission apparatus increases.

If the number of wavelengths receivable by the reception side optical transmission apparatus is identical to the number of the transmission wavelengths of the apparatus, the judging unit 60, based on the data including the level information of wavelengths, outputs to the tilt control unit 57, an offset change instruction to change the offset such that variation of levels between wavelengths is reduced. If the variation of levels between wavelengths becomes less than or equal to a target value, the judging unit 60 outputs a write instruction to the writing unit 58. The target value is preset in the judging unit 60.

In the reception side apparatus case, the judging unit 60 receives from the ADC 63, the levels of optical signals of respective wavelengths measured by the PDs 72 to 75 and outputs the levels to the frame unit 91.

In the configuration when the optical transmission apparatus A31 acts as the transmission side optical transmission device, the offset unit may include the extracting unit 52, the tilt control unit 57, the judging unit 60, the amplifier control unit 61, and the O/E converters 83 to 86 of the optical modulators 64 to 67. The transmitting unit may include the inserting unit 51, the checking unit 53, the disassembling unit 54, the E/O converters 79 to 82 of the optical modulators 64 to 67, the amplifiers 68 to 71, the optical switch 76, the multiplexing unit 87 of the multiplexing/demultiplexing unit 77, and the postamplifier 89 of the amplifying unit 78.

In the configuration when the optical transmission apparatus A31 acts as the reception side optical transmission device, the receiving unit may include the preamplifier 90 of the amplifying unit 78, the demultiplexing unit 88 of the multiplexing/demultiplexing unit 77, the PDs 72 to 75, and the O/E converters 83 to 86 of the optical modulators 64 to 67. The measuring unit may include the PDs 72 to 75, the ADC 63, and the judging unit 60. The notifying unit may include the frame unit 91, the inserting unit 51, the judging unit 60, the E/O converters 79 to 82 of the optical modulators 64 to 67, the amplifiers 68 to 71, the optical switch 76, the multiplexing unit 87 of the multiplexing/demultiplexing unit 77, and the postamplifier 89 of the amplifying unit 78.

In the third example of the optical transmission apparatus, the frame unit 91 may be implemented by a programmable logic device such as an FPGA, or an ASIC, for example. The hardware configurations implementing the table 56, the judging unit 60, the tilt control unit 57, the writing unit 58, the amplifier control unit 61, the inserting unit 51, the extracting unit 52, the disassembling unit 54, and the assembling unit 55 may be the same as the second example of the optical transmission apparatus described above.

FIG. 19 is a diagram of an example of a frame in which information of levels of wavelengths is written. If the optical transmission apparatus A31 is the reception side optical transmission device, as depicted in FIG. 19, for example, a frame 151 has a frame header 152 followed by a field 153 storing wavelength names and optical level values for respective wavelengths and has, for example, a 16-bit CRC code 154 at the end. The frame header 152 stores information for synchronizing the frame. The CRC code 154 is used for checking the validity of the frame.

In FIG. 19, an upper row of the field 153 storing wavelength names and optical level values indicates wavelengths and levels, and a lower row indicates an actually stored image by using ASCII codes. For example, in the example depicted in FIG. 19, the levels of the wavelengths λ₁ and λ₂ are −14.5 dBm and −20.0 dBm, which are both within the dynamic range of the reception side optical transmission apparatus. For example, the levels of the wavelengths λ₃ and λ₄ are −26.0 dBm and, for example, −26.0 dBm is a lower limit value of the dynamic range of the reception side optical transmission apparatus and if a level at the reception side optical transmission apparatus is less than or equal to the lower limit value, i.e., if the level cannot be received by the reception side optical transmission apparatus, the lower limit value is stored.

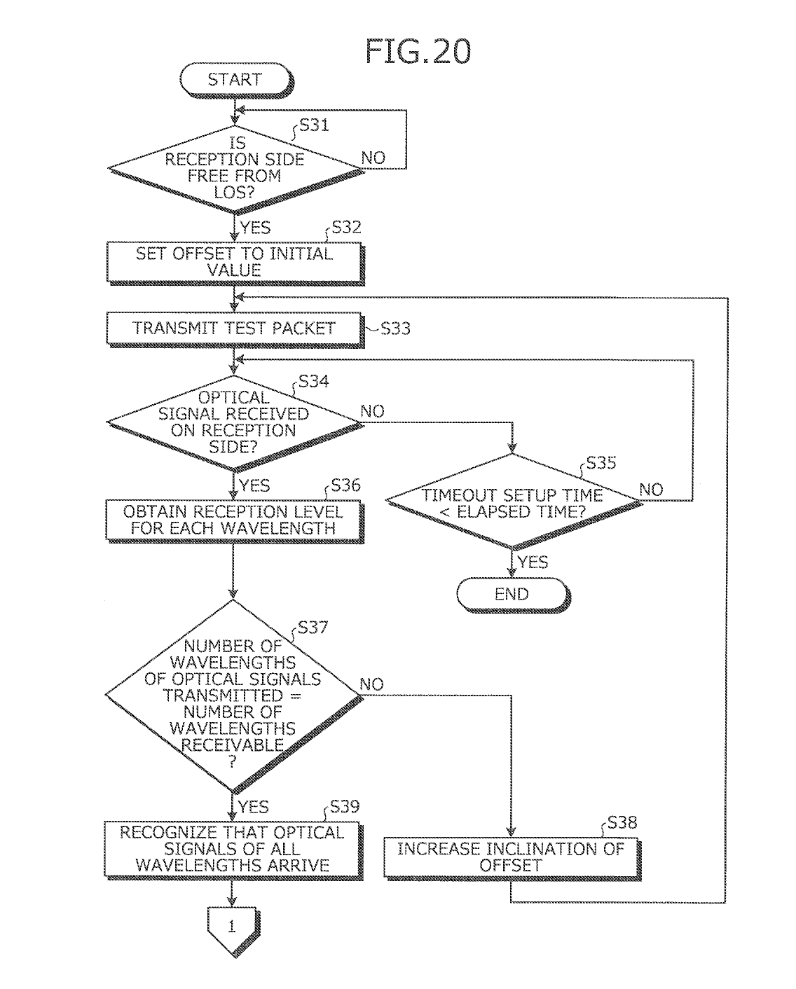

FIG. 20 is a diagram of a second example of the procedure, at the optical transmission apparatus according to the embodiment, for adjusting the offset related to the tilt and FIG. 12 is a diagram continued from FIG. 20. As depicted in FIG. 20, when a process of adjusting the offset related to the tilt is started at the transmission side optical transmission apparatus, the transmission side optical transmission apparatus first determines whether the reception side of the apparatus is free from the LOS (loss of signal) as is the case with step S11 described above (step S31).

If the reception side of the transmission side optical transmission apparatus is not free from the LOS (step S31: NO), the transmission side optical transmission apparatus waits for recovery from the LOS. Alternatively, the transmission side optical transmission apparatus may generate an error and terminate the process. If the reception side of the transmission side optical transmission apparatus is free from the LOS (step S31: YES), the transmission side optical transmission apparatus sets the offset to the initial value (step S32) and transmits a test packet to the WDM ring network 38 (step S33) as is the case with steps S12 and S13 described above. The initial value may be zero.

Subsequently, the transmission side optical transmission apparatus determines whether an optical signal from the WDM ring network 38 has been received on the reception side of the transmission side optical transmission apparatus (step S34). If an optical signal has been received (step S34: YES), the procedure goes to step S36. If an optical signal has not been received (step S34: NO), the transmission side optical transmission apparatus waits for the reception of the optical signal and, as is the case with the step S15 described above, if the elapsed time of the waiting state exceeds a predefined timeout setup time (step S35: YES), the transmission side optical transmission apparatus may generate an error and terminate the process.

Before the elapsed time of the waiting state reaches the timeout setup time (step S35: NO), if the optical signal is received on the reception side of the transmission side optical transmission apparatus (step S34: YES), the optical signal is amplified by the preamplifier 90 and demultiplexed by the demultiplexing unit 88 into the optical signals of respective wavelengths. The optical signals demultiplexed according to wavelength have data of the frame depicted in FIG. 19, for example, and this data includes information of the level of each wavelength when the reception side optical transmission apparatus receives an optical signal transmitted from the transmission side optical transmission apparatus. The optical signals demultiplexed according to wavelength are sent by the optical switch 76, to the O/E converters 83 to 86 of the corresponding wavelength.

Since the reception side of the transmission side optical transmission apparatus is free from the LOS as confirmed at step S31, the level of an optical signal of at least one wavelength falls within the dynamic range of the O/E converters 83 to 86. Therefore, an optical signal of at least one wavelength is received and converted into an electronic signal by the O/E converters 83 to 86. The transmission side optical transmission apparatus causes the extracting unit 52 to synchronize the frame based on the signals output from the O/E converters 83 to 86, checks the validity of the data by using the CRC code, for example, and obtains the level of each wavelength at the reception side optical transmission apparatus. Therefore, the transmission side optical transmission apparatus obtains a reception level for each wavelength at the reception side optical transmission apparatus (step S36).

The transmission side optical transmission apparatus then causes the judging unit 60 to recognize the number of wavelengths receivable by the reception side optical transmission apparatus based on the reception level of each wavelength at the reception side optical transmission apparatus and to judge whether the number of wavelengths receivable by the reception side optical transmission apparatus is identical to the number of wavelengths of the optical signals transmitted by the apparatus (step S37). If the number of wavelengths receivable by the reception side optical transmission apparatus is identical to the number of the transmission wavelengths of the transmission side optical transmission apparatus (step S37: YES), the procedure goes to step S39.

If the number of wavelengths receivable by the reception side optical transmission apparatus is not identical to the number of the transmission wavelengths (step S37: NO), the transmission side optical transmission apparatus causes the judging unit 60 to instruct the tilt control unit 57 to make the inclination of offset larger. However, immediately after the start of the process of adjusting the offset related to the tilt, the offset is set to the initial value and it is unknown whether the direction of making the inclination of offset larger is correct. Therefore, if the number of wavelengths receivable by the reception side optical transmission apparatus is not identical to the number of the transmission wavelengths of the apparatus in a first comparison, the judging unit 60 judges the inclination direction of the tilt between wavelengths at the reception side optical transmission apparatus, based on the reception level of each wavelength at the reception side optical transmission apparatus. The judging unit 60 instructs the tilt control unit 57 to apply the offset having inclination in the direction opposite to the inclination direction of the tilt.

The tilt control unit 57 notifies the amplifier control unit 61 of the offset having inclination in the direction opposite to the inclination direction of the tilt and, as a result, in the amplifier control unit 61, the offset is set to have the inclination in the direction opposite to the inclination direction of the tilt. A test packet is transmitted to the WDM ring network 38 with the set offset applied (step S33). The transmission side optical transmission apparatus executes the operations at steps S34 to S37 for the transmission of this packet. If the number of wavelengths receivable by the reception side optical transmission apparatus is identical to the number of the transmission wavelengths (step S37: YES), the procedure goes to step S39.

If the number of wavelengths receivable by the reception side optical transmission apparatus is not identical to the number of the transmission wavelengths in the second or later comparison (step S37: NO), the transmission side optical transmission apparatus causes the judging unit 60 to instruct the tilt control unit 57 to make the inclination of offset larger.

The tilt control unit 57 notifies the amplifier control unit 61 of the offset changed to have the larger inclination and, as a result, in the amplifier control unit 61, the offset changed to have the larger inclination is set (step S38). The transmission side optical transmission apparatus transmits to the WDM ring network 38, the test packet with the offset having the larger inclination applied (step S33).

The transmission side optical transmission apparatus repeats the operations at steps S34 to S38 for the transmission of the test packet with the offset set at step S38 applied until the number of wavelengths receivable by the reception side optical transmission apparatus becomes identical to the number of the transmission wavelengths at step S37. When the number of wavelengths receivable by the reception side optical transmission apparatus becomes identical to the number of the transmission wavelengths at step S37, the transmission side optical transmission apparatus uses the judging unit 60 to recognize that the optical signals of all the wavelengths transmitted from the apparatus arrive at the reception side optical transmission apparatus and to judge that that the offset is roughly correct (step S39).

The transmission side optical transmission apparatus retains, as a provisional value in memory, the offset when the number of wavelengths receivable by the reception side optical transmission apparatus becomes identical to the number of the transmission wavelengths. The transmission side optical transmission apparatus may cause the writing unit 58 to write, as a provisional value into the table 56, the offset when the number of wavelengths receivable by the reception side optical transmission apparatus becomes identical to the number of the transmission wavelengths of the apparatus. In this example, the offset is written into the table 56. As a result of comparing the number of wavelengths receivable by the reception side optical transmission apparatus with the number of the transmission wavelengths for the first time after the start of the process of adjusting the offset related to the tilt, if the number of wavelengths receivable by the reception side optical transmission apparatus is identical to the number of the transmission wavelengths, the initial value of the offset is used as the provisional value.

Since the reception side optical transmission apparatus can receive the optical signals of all the wavelengths transmitted from the transmission side optical transmission apparatus at this point, the packet communication is enabled from the transmission side optical transmission apparatus to the reception side optical transmission apparatus. To enable the packet communication from the reception side optical transmission apparatus to the transmission side optical transmission apparatus, the optical transmission apparatus used as the transmission side optical transmission apparatus is defined as the reception side optical transmission apparatus, while the optical transmission apparatus used as the reception side optical transmission apparatus is defined as the transmission side optical transmission apparatus, and the operations at steps S31 to S39 described above is executed in the optical transmission apparatus defined as the transmission side optical transmission apparatus. If the packet communication becomes possible without a lack of wavelength in the both directions, the procedure goes to the process depicted in FIG. 12. The process depicted in FIG. 12 is as described above and therefore, will not be described again.

Description will be made of an example of operation of the reception side optical transmission apparatus when the transmission side optical transmission apparatus executes the operations at steps S31 to S39 described above. The configuration of the reception side optical transmission apparatus is the same as the configuration of the transmission side optical transmission apparatus and is the same configuration as the optical transmission apparatus A31 depicted in FIG. 18, for example. Therefore, the reference numerals added to the names of units in FIG. 18 are used in the description of operation of the reception side optical transmission apparatus.

When the transmission side optical transmission apparatus transmits to the WDM ring network 38, an optical signal assigned with data formed by disassembling the test packet at step S33 in FIG. 20, the reception side optical transmission apparatus receives the optical signal from the WDM ring network 38. The reception side optical transmission apparatus causes the preamplifier 90 to amplify the received optical signal and the demultiplexing unit 88 to perform demultiplexing into optical signals of respective wavelengths. The optical signals demultiplexed according to wavelength are sent by the optical switch 76, to the PDs 72 to 75 of the corresponding wavelength.

The PDs 72 to 75 measure the levels of the optical signals, for each wavelength and output electronic signals that correspond to the levels of the optical signals. The electronic signals output from the PDs 72 to 75 are converted into digital signals by the ADC 63 and turned to data of a frame, for example, as depicted in FIG. 19, by the frame unit 91 through the judging unit 60. Information of the levels of the wavelengths is written into this data.

At the reception side optical transmission apparatus, the inserting unit 51 outputs to the checking unit 53, a test packet that includes the data framed by the frame unit 91. The checking unit 53 checks the destination of the test packet output from the inserting unit 51, supplies the table 56 with the information of the destination of the test packet, and outputs the test packet to the disassembling unit 54. At this time point immediately after the start of the process of adjusting the offset related to the tilt, the offset has not been written into the table 56. Therefore, the table 56 supplies the amplifier control unit 61 with a preset initial value.

The disassembling unit 54 outputs to the E/O converters 79 to 82, the test packet output from the checking unit 53. The test packet having the same data is sent to the E/O converters 79 to 82. The test packet is converted into optical signals by the E/O converters 79 to 82, amplified by the amplifiers 68 to 71, which are controlled by the amplifier control unit 61 such that the initial value of the offset is applied, and are output through the optical switch 76, the multiplexing unit 87, and the postamplifier 89 to the WDM ring network 38. The test packet having the information of levels of wavelengths output from the reception side optical transmission apparatus to the WDM ring network 38 is received by the transmission side optical transmission apparatus at step S34 in FIG. 20.

The operation of the reception side optical transmission apparatus that receives the test packet transmitted by the transmission side optical transmission apparatus at step S22 of FIG. 12 is as described in the first example of the procedure of adjusting the offset related to the tilt. Therefore, the operation will not be described again.

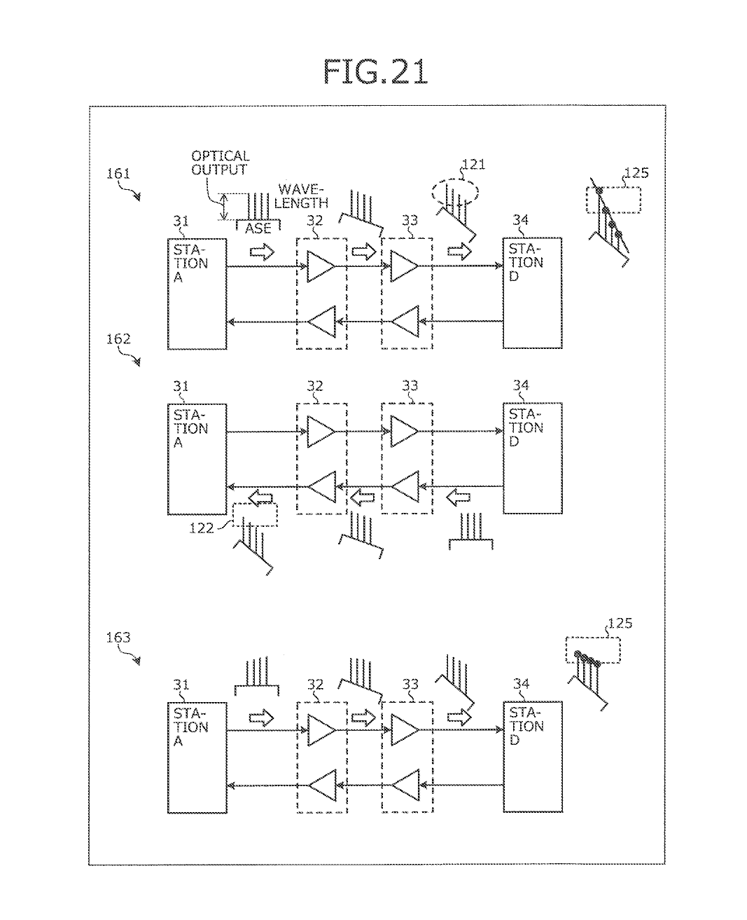

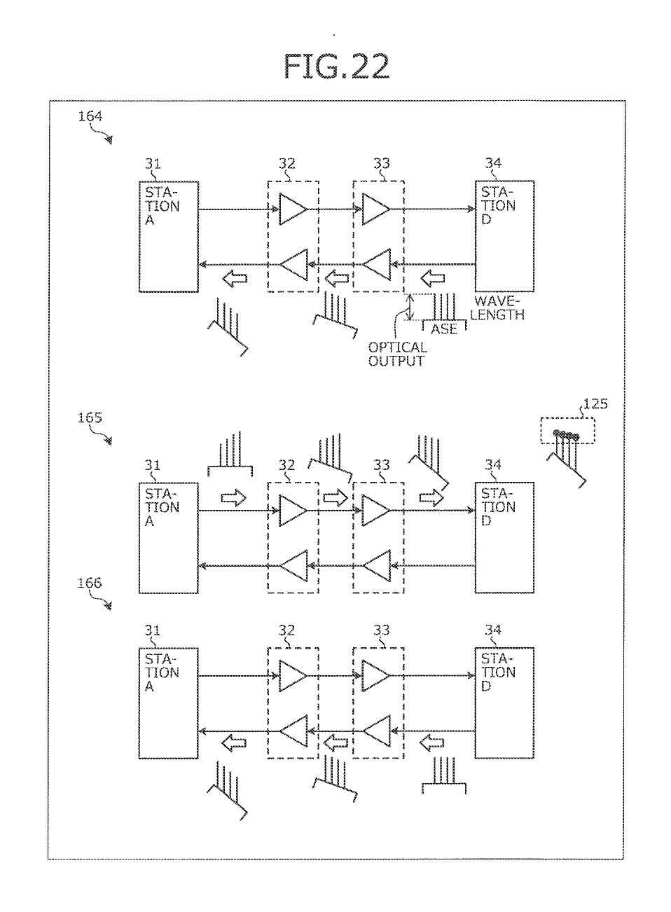

FIG. 21 is a diagram of a third specific example of the procedure of adjusting the offset related to the tilt, and FIG. 22 is a diagram continued from FIG. 21, while FIG. 17 is a diagram continued from FIG. 22. The example depicted in FIGS. 21, 22, and 17 is a specific example of the second example of the procedure of adjusting the offset related to the tilt described above. In the description of this example, the offset related to the tilt is adjusted between the optical transmission apparatus A31 and the optical transmission apparatus D34.

In FIGS. 21, 22, and 17, the optical transmission apparatus A31 is denoted by STATION A and the optical transmission apparatus D34 is denoted by STATION D. The optical transmission apparatus B32 and the optical transmission apparatus C33 act as optical relay apparatuses. An optical signal output from the optical transmission apparatus A31 is relayed by the optical transmission apparatus B32 and the optical transmission apparatus C33 and arrives at the optical transmission apparatus D34, and an optical signal output from the optical transmission apparatus D34 arrives at the optical transmission apparatus A31 through the reverse route. The number of wavelengths of the optical signals transmitted by the optical transmission apparatus A31 and the optical transmission apparatus D34 is four.

In FIG. 21, as indicated by reference numeral 161, the optical transmission apparatus A31 transmits the optical signals of the test packet with the offset set to the initial value. The transmitted optical signals are subject to the tilt 121 between wavelengths consequent to the characteristics of the linear amplifiers and the transmission lines in the relay points of the optical transmission apparatus B32 and the optical transmission apparatus C33. As a result, among the optical signals transmitted from the optical transmission device A31, although optical signals of some wavelengths are within the dynamic range of the optical transmission apparatus D34, optical signals of the remaining wavelengths are not within the dynamic range of the optical transmission apparatus D34. In this example, among the optical signals of the four wavelengths transmitted from the optical transmission apparatus A31, optical signals of two wavelengths fall within a dynamic range 125 of the optical transmission apparatus D34. Therefore, the optical transmission apparatus D34 recognizes the reception of the optical signals of the two wavelengths.

In FIG. 21, as indicated by reference numeral 162, the optical transmission apparatus D34 frames the levels of the received optical signals as depicted in FIG. 19, for example, assigns the framed data to optical signals of all the wavelengths, and transmits the optical signals of all the wavelengths at the same level. The transmitted optical signals are subject to the tilt 122 between wavelengths consequent to the characteristics of the linear amplifiers and the transmission lines in the relay points of the optical transmission apparatus C33 and the optical transmission apparatus B32. However, since the state of LOL or LOS does not exist between the optical transmission apparatus A31 and the optical transmission apparatus D34, the level of an optical signal of at least one wavelength falls within the dynamic range of the optical transmission apparatus A31. Therefore, the optical transmission apparatus A31 recognizes the number of wavelengths receivable by the reception side optical transmission apparatus based on the reception levels of the respective wavelengths at the reception side optical transmission apparatus, included in the received optical signal and judges that the number of wavelengths receivable by the reception side optical transmission apparatus is not identical to the number of the wavelengths of the optical signals transmitted by the optical transmission apparatus A31.

In FIG. 21, as indicated by reference numeral 163, the optical transmission apparatus A31 obtains the inclination direction of the tilt between wavelengths at the reception side optical transmission apparatus, based on the reception levels of the respective wavelengths at the reception side optical transmission apparatus and transmits the optical signals of the test packet with the offset set to have inclination in the direction opposite to the inclination direction of the tilt. As a result, the number of wavelengths falling within the dynamic range 125 of the optical transmission apparatus D34 is increased and, for example, it is assumed that optical signals of three wavelengths fall within the dynamic range 125 of the optical transmission apparatus D34. In this case, the optical transmission apparatus D34 recognizes the reception of the optical signals of the three wavelengths. In the example indicated by reference numeral 163 in FIG. 21, the offset is set toward a longer wavelength.

In FIG. 22, as indicated by reference numeral 164, the optical transmission apparatus D34 frames the levels of the received optical signals as depicted in FIG. 19, for example, assigns the framed data to optical signals of all the wavelengths, and transmits the optical signals of all the wavelengths at the same level. The optical transmission apparatus A31 receives an optical signal of at least one wavelength and recognizes the number of wavelengths receivable by the reception side optical transmission apparatus based on the reception levels of the respective wavelengths at the reception side optical transmission apparatus, included in the received optical signal. Although the optical transmission apparatus A31 judges that the number of wavelengths receivable by the reception side optical transmission apparatus is not identical to the number of the wavelengths of the optical signals transmitted by the optical transmission apparatus A31, since the number of wavelengths receivable by the reception side optical transmission apparatus is increased as compared to the previous time, it can be confirmed that the direction of the offset is correct.

In FIG. 22, as indicated by reference numeral 165, the optical transmission apparatus A31 transmits the optical signals of the test packet with an offset larger than the previous time. As a result, the number of wavelengths falling within the dynamic range 125 of the optical transmission apparatus D34 is increased and, for example, it is assumed that optical signals of four wavelengths fall within the dynamic range 125 of the optical transmission apparatus D34. In this case, the optical transmission apparatus D34 recognizes the reception of the optical signals of the four wavelengths.

In FIG. 22, as indicated by reference numeral 166, the optical transmission apparatus D34 frames the levels of the received optical signals as depicted in FIG. 19, for example, assigns the framed data to optical signals of all the wavelengths, and transmits the optical signals of all the wavelengths at the same level. The optical transmission apparatus A31 receives an optical signal of at least one wavelength and recognizes the number of wavelengths receivable by the reception side optical transmission apparatus based on the reception levels of the respective wavelengths at the reception side optical transmission apparatus, included in the received optical signal. The optical transmission apparatus A31 recognizes that the number of wavelengths receivable by the reception side optical transmission apparatus is identical to the number of the wavelengths of the optical signals transmitted by the apparatus. The optical transmission apparatus A31 stops the transmission of the test packet.

At this point, with regard to the transmission of the optical signals from the optical transmission apparatus A31 to the optical transmission apparatus D34, the levels of the optical signals of all the wavelengths fall within the dynamic range of the optical transmission apparatus D34 although the tilt between wavelengths occurs. Therefore, since a packet signal from the optical transmission apparatus A31 to the optical transmission apparatus D34 can be recognized, a provisional value of the offset is determined.

Subsequently, the offset in the optical transmission apparatus D34 is adjusted such that the levels of the optical signals of all the wavelengths transmitted from the optical transmission apparatus D34 fall within the dynamic range of the optical transmission apparatus A31 in the same way as the procedure depicted in FIGS. 21 and 22. As a result, although the tilt between wavelengths occurs, since a packet signal can also be recognized with regard to the transmission of the optical signals from the optical transmission apparatus D34 to the optical transmission apparatus A31, a provisional value of the offset is determined. When the optical transmission apparatus A31 and the optical transmission apparatus D34 become capable of mutually recognizing a packet signal, the process depicted in FIG. 17 is executed at both the optical transmission apparatus A31 and the optical transmission apparatus D34. The process depicted in FIG. 17 is as described above and will not be described again.

According to the optical transmission apparatus depicted in FIG. 18, and the optical transmission system having the optical transmission apparatus depicted in FIG. 18, or the optical transmission method depicted in FIGS. 20 to 22, the transmission side optical transmission apparatus can obtain the inclination direction of the tilt between wavelengths at the reception side optical transmission apparatus, based on the reception levels of respective wavelengths at the reception side optical transmission apparatus. By obtaining the inclination direction of the offset such that the direction becomes opposite to the incline direction of the tilt and repeating the transmission of optical signals while the inclination of the offset is made larger, the transmission side optical transmission apparatus can obtain the offset enabling the reception side optical transmission apparatus to receive the optical signals of all the wavelengths transmitted by the transmission side optical transmission apparatus. Therefore, the tilt correction can be performed at the transmission side optical transmission apparatus such that the reception side optical transmission apparatus can receive the optical signals of all the wavelengths transmitted by the transmission side optical transmission apparatus.

For example, in the optical transmission system depicted in FIG. 5, the adjustment of the offset applied to optical signals transmitted from the optical transmission apparatus A31 to the optical transmission apparatus B32 is completed as in the first example or the second example of the procedure of adjusting the offset related to the tilt described above, for example. In the same way, the adjustments are completed for the offsets from the optical transmission apparatus B32 to the optical transmission apparatus C33, from the optical transmission apparatus C33 to the optical transmission apparatus D34, from the optical transmission apparatus D34 to the optical transmission apparatus E35, from the optical transmission apparatus E35 to the optical transmission apparatus F36, and from the optical transmission apparatus F36 to the optical transmission apparatus A31.

Subsequently, the monitoring terminal 37 applies the offset and transmits the optical signals of a packet provided with information of the offset applied to optical signals transmitted from the optical transmission apparatus A31 to the optical transmission apparatus B32. Similarly, the optical transmission apparatus B32 applies the offset and transmits to the optical transmission apparatus C33, the optical signals of a packet provided with the information of the offset received from the optical transmission apparatus A31 and information of the offset applied to optical signals transmitted from the optical transmission apparatus B32 to the optical transmission apparatus C33. In the same way, the information of the offset is sequentially transmitted from the optical transmission apparatus B32 to the optical transmission apparatus C33, from the optical transmission apparatus C33 to the optical transmission apparatus D34, from the optical transmission apparatus D34 to the optical transmission apparatus E35, from the optical transmission apparatus E35 to the optical transmission apparatus F36, and from the optical transmission apparatus F36 to the optical transmission apparatus A31.

As a result, the information of the offsets at the nodes of the WDM ring network 38 is aggregated in the optical transmission apparatus A31. The optical transmission apparatus A31 calculates an offset in the case of multicasting a packet based on the aggregated offset information. The optical transmission apparatus A31 transmits to the other optical transmission apparatuses 32 to 36, the offset calculated for multicast. As a result, all the optical transmission apparatuses 31 to 36 can set the offset in the case of multicasting a packet.

The optical transmission system, the optical transmission apparatus, and the optical transmission method produce an effect of enabling tilt correction in optical-packet time division multiplex transmission.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An optical transmission system comprising:
a transmission side optical transmission apparatus including:
a transmitting unit configured to transmit optical signals of a predetermined number of differing wavelengths, and
a processor configured to apply to the optical signals transmitted from the transmitting unit, a predetermined offset related to a tilt; and
a reception side optical transmission apparatus including:
a receiving unit configured to receive the optical signals transmitted from the transmitting unit,
a measuring unit configured to measure an optical signal count of the optical signals receivable by the receiving unit, and
a notifying unit configured to give notification of the optical signal count measured by the measuring unit, wherein
the processor adjusts the offset in an increasing direction when the optical signal count notified by the notifying unit increases, and adjusts the offset in a decreasing direction when the optical signal count notified by the notifying unit decreases.

2. The optical transmission system according to claim 1, wherein
the processor adjusts the offset until an optical signal count of the optical signals transmitted from the transmitting unit becomes identical to the optical signal count notified by the notifying unit.

3. The optical transmission system according to claim 1, wherein
the notifying unit gives notification of the optical signal count measured by the measuring unit, via a blinking of light.

4. The optical transmission system according to claim 1, wherein
the notifying unit gives notification of the optical signal count measured by the measuring unit, by using reception levels of the optical signals received by the receiving unit.

5. The optical transmission system according to claim 4, wherein
the processor judges an inclination direction of a tilt, based on the reception levels notified by the notifying unit and adjusts the offset, based on the inclination direction of the tilt.

6. An optical transmission apparatus comprising:
a transmitting unit configured to transmit optical signals of a predetermined number of differing wavelengths; and
a processor configured to apply to the optical signals transmitted from the transmitting unit, a predetermined offset related to a tilt, wherein
the processor, with respect to the optical signals transmitted from the transmitting unit, adjusts the offset in an increasing direction when an optical signal count of the optical signals receivable on a reception side increases, and adjusts the offset in a decreasing direction when the optical signal count of the optical signals receivable on the reception side decreases.

7. The optical transmission apparatus according to claim 6, wherein
the processor adjusts the offset until an optical signal count of the optical signals transmitted from the transmitting unit becomes identical to the optical signal count of the optical signals receivable on the reception side.

8. An optical transmission method comprising:
applying to optical signals of a predetermined number of differing wavelengths, an offset related to a tilt, and transmitting the optical signals by a transmission side optical transmission apparatus; and
receiving the optical signals, measuring an optical signal count of the optical signals receivable, and notifying the transmission side optical transmission apparatus of the measured optical signal count, by a reception side optical transmission apparatus, wherein
the applying of the offset by the transmission side optical transmission apparatus includes adjusting the offset in an increasing direction, when the notified optical signal count increases, and adjusting the offset in a decreasing direction when the notified optical signal count decreases.
